(19) United States
(12) Patent Application Publication
(10) Pub. No.: US 2019/0114694 A1
(43) Pub. Date: Apr. 18, 2019

(54) COMMODITY/SERVICE PURCHASE SUPPORT METHOD, SYSTEM, AND PROGRAM

(71) Applicant: EC BIRD INCORPORATED, Tokyo (JP)

(72) Inventor: Reiko Horimoto, Tokyo (JP)

(73) Assignee: EC BIRD INCORPORATED, Tokyo (JP)

(21) Appl. No.: 15/779,129

(22) PCT Filed: Nov. 28, 2016
(86) PCT No.: PCT/JP2016/085141

§ 371 Date: Dec. 28, 2018

(30) Foreign Application Priority Data
Nov. 27, 2015 (JP) 2015-232316

(51) Int. Cl. G06Q 30/06; G06F 16/957; G06F 3/0481

(52) U.S. Cl. CPC G06Q 30/0641; G06F 3/04817; G06F 16/9577

(57) ABSTRACT

A user ID is assigned to each user of a portal site. Web page browsing history information is generated for each user, and is associated with the corresponding user ID. User characteristic information is generated for each user based on the browsing history information, and is associated with the corresponding user ID. An icon containing an image identifying goods/services displayed on a browsed page corresponding to the browsing history information is generated, and is assigned an icon ID. Each icon ID is associated with a URL of the corresponding browsed page, corresponding goods/services attribute information, and the corresponding user ID and user characteristic information. Each individual user is enabled to publish, via the corresponding user terminal, the user's own icon to other users.

### TECHNICAL FIELD

The present invention relates to a goods/services purchase assistance method, system and program, and more specifically, to a goods/services purchase assistance method, system and program which assist a user to search for and/or purchase goods or services on a web page by generating icons specific to each individual user in relation to goods or services on browsed web pages according to browsing history information including single or multiple websites browsed, so that users can mutually refer to useful information (for example, other users' recommendation information and favorite information) via these icons.

### BACKGROUND ART

Conventionally, websites such as those relating to fashions and apparels enhance browsing convenience for users by, for example, listing images of various goods, such as clothes, shoes, and bags, on their web pages. Users of those websites may access a website of their favorite brand or the like to browse images of clothes or the like listed on the web page, thereby catching trends and becoming familiar with the latest information.

With today's diversification in brands and the like which results in a number of brand web pages coexisting in the Internet, however, there is a growing demand for organized and readily available information that matches the users' tastes and preferences. The call for organized information supply which suits users' tastes and preferences is not limited to brands, but is relevant to other fields as well.

In view of the above, a technique has been proposed in which access history information that associates an address of a website accessed by a user with a keyword in that web page is used to provide relevant web page information indicating website addresses which match a keyword that belongs to another user (see, for example, Patent Literature 1).

Another technique has also been proposed, which facilitates a user to manage web page browsing history by visualizing browsing history of web pages accessed by the user, which can be displayed in a list on a screen (see, for example, Patent Literature 2).

### PRIOR ART LITERATURES

### Patent Literatures

[Patent Literature 1] Japanese Unexamined Patent Application Publication No. 2011-22724

[Patent Literature 2] Japanese Unexamined Patent Application Publication No. 2009-075908

### SUMMARY OF INVENTION

### Problem to be Solved by the Invention

The technique disclosed in Patent Literature 1, however, merely provides website addresses which match a keyword. The icons generated there simply function as shortcuts to those addresses and as such, do not serve to summarize information on their own.

Further, the technique does not allow generation of a user-specific icon, nor does it enable users to mutually refer to useful information (for example, other users' recommendation information and favorite information) by allowing search and sharing of registered information via the icons.

Also, the technique disclosed in Patent Literature 2 merely allows for visualization of browsing history of web pages accessed by a user in a list displayable on a screen. The technique does not allow the history information to serve as useful information (for example, other users' recommendation information and favorite information) which can be mutually referenced among users.

The circumstances described above are addressed by the present invention, an objective of which is to provide a goods/services purchase assistance method, system and program to assist a user of a portal site to swiftly and easily search for or purchase desired goods or services (hereinafter, occasionally referred to as “goods/services”), even where goods and services of various brands, makers or providers (hereinafter, occasionally referred to as “makers/providers”) are distributed among different web pages for selling goods or services provided in single or multiple websites.

Another objective of the present invention is to provide a goods/services purchase assistance method, system and program that can easily and securely assist search or purchase of goods or services by the user using the portal site.

Still another objective of the present invention is to provide a goods/services purchase assistance method, system and program that allows for promoting sales of goods or services on web pages for selling goods or services (hereinafter, occasionally referred to as “goods/services sales web pages”) included in the website, simply by obtaining web page browsing history information of the user using the portal site.

Yet still another objective of the present invention is to provide a goods/services purchase assistance method, system and program that enable the user using the portal site to integrally manage his or her browsing history information relating to the website.

Other, unspecified objectives of the present invention will become apparent from the following description and the accompanying drawings.

### Means to Solve the Problem

(1) According to a first aspect of the present invention, a goods/services purchase assistance method is provided. The goods/services purchase assistance method assists purchase of goods/services from one or more website through a portal site upon request from a user terminal, wherein the one or more websites, each including one or more goods/services sales web pages, are browsable from a plurality of user terminals on the portal site via a communication network. The method is characterized by comprising:

storing user identification information assigned to each individual user of the portal site;

generating browsing history information of each individual user by specifying, among the goods/services sales web pages, a browsed web page browsed by the user via the user terminal, and storing the browsing history information in association with the corresponding user identification information;

generating user characteristic information (for example, preference information) that represents a user characteristic of each individual user based on the browsing history information, and storing the user characteristic information in association with the corresponding user identification information;

generating an icon that is specific to the browsed web page corresponding to the browsing history information and contains an image identifying goods/services displayed on the browsed web page, and storing each individual icon with icon identification information assigned thereto;

storing the icon identification information in association with web page identification information (for example, the URL) of the corresponding browsed web page, predetermined goods/services attribute information (such as, for example, the price and the maker or provider) relating to the goods/services displayed on the corresponding browsed web page, and the user identification information and the user characteristic information of the user who browsed the corresponding browsed web page; and

enabling each individual user to publish, via the corresponding user terminal, the user's own icon to other users,

wherein in displaying published icons on the corresponding user terminal in response to each individual user requesting display, where two or more duplicate icons exist which have identical web page identification information and different user identification information, a higher priority is assigned to an icon published by a publishing user who is different than the requesting user and whose user characteristic is more similar than others to that of the requesting user, and

the published icons are displayed according to the assigned priorities, thereby allowing the requesting user to use the displayed icons as reference information during goods/service purchase.

Owing to the aforementioned features of the goods/services purchase assistance method according to the first aspect of the present invention, where an individual registered user of the portal site uses the user terminal to browse a goods/services sales web page of the website to explore goods/services of interest, icons relating to the above goods/services of interest (relevant icons) selected among all icons published by other users of the portal site are displayed on the user terminal of the browsing user, so that the displayed icons can be used as reference information. In that case, a number of icons are displayed as search results on the user terminal of the browsing user. Where those icons include two or more duplicate icons that have identical web page identification information and different user identification information (each having different icon identification information), an icon published by a user whose user characteristic (for example, preference) is more similar than others to that of the user requesting display of the above relevant icons is selected from among the two or more duplicate icons for preferential display in the search results.

Accordingly, the above user requesting display of the relevant icons can easily learn in what goods/services from the website each of other users having the similar user characteristic as his or her own is interested (past goods/services browsing record), and what goods/services are being recommended by those other users (recommended goods/services). Knowing such facts enables the user requesting display of the relevant icons to avoid spending hours randomly going through a number of web pages within the website in search of the goods/services of interest, and therefore is extraordinarily useful to the same user.

Thus, the goods/services purchase assistance method according to the first aspect of the present invention can assist the user of the portal site to swiftly and easily search for or purchase desired goods or services, even where goods and services of various brands, makers or providers, prices, designs, and the like are spread over a number of goods/services sales web pages in the website. Such capability translates into the ability to provide easy and secure assistance for search or purchase of goods or services by the user utilizing the portal site.

From the standpoint of the operation company of the website in which the goods/services sales web pages are provided, it is possible to promote sales of goods or services on the goods/services sales web pages included in the website simply by obtaining web page browsing history information of individual users utilizing the portal site.

Moreover, since the web page browsing history information of individual users utilizing the portal site can be accumulated in the portal site, each user can integrally manage the browsing history information of different websites through the icons of a single, common format.

(2) In a preferred example of the goods/services purchase assistance method according to the first aspect of the present invention, the user's preference relating to a particular item of goods/services is used as the user characteristic.

(3) In another preferred example of the goods/services purchase assistance method according to the first aspect of the present invention, the user's preference obtained by identifying a plurality of words that appear frequently in the goods/services attribute information of the user and reprioritizing the identified words is used as the user characteristic.

(4) In yet another preferred example of the goods/services purchase assistance method according to the first aspect of the present invention, only the duplicate icon published by a user assigned a highest priority is selectively displayed where two or more duplicate icons are present for display on the user terminal.

(5) In yet another preferred example of the goods/services purchase assistance method according to the first aspect of the present invention, the goods/services attribute information of the icon is updated either at predetermined time intervals, or where the same icon has been selected by any of the users for a predetermined number of times or more.

(6) In yet another preferred example of the goods/services purchase assistance method according to the first aspect of the present invention, each individual user is assigned a dedicated icon display field that displays icons generated from the plurality of websites, and icons associated with the user identification information corresponding to a user other than the user owing the icon display field, in addition to icons associated with the user identification information corresponding to the user owning the icon display field, are displayable in the icon display field.

(7) According to a second aspect of the present invention, a goods/services purchase assistance system is provided. The system assists purchase of goods/services from one or more website through a portal site upon request from a user terminal, wherein the one or more websites, each including one or more goods/services sales web pages, are browsable from a plurality of user terminals on the portal site via a communication network. The system is characterized by comprising:

a user identification information memory means that stores user identification information assigned to each individual user of the portal site;

a browsing history information memory means that generates browsing history information of each individual user by specifying, among the goods/services sales web pages, a browsed web page browsed by the user via the user terminal, and stores the browsing history information in association with the corresponding user identification information;

a user characteristic information memory means that generates user characteristic information (for example, preference information) that represents a user characteristic of each individual user based on the browsing history information, and stores the user characteristic information in association with the corresponding user identification information;

an icon generation means that generates an icon that is specific to the browsed web page corresponding to the browsing history information and contains an image identifying goods/services displayed on the browsed web page, and stores each individual icon with icon identification information assigned thereto,

an icon information memory means that stores the icon identification information in association with web page identification information (for example, the URL) of the corresponding browsed web page, predetermined goods/services attribute information (such as, for example, the price and the maker or provider) relating to the goods/services displayed on the corresponding browsed web page, and the user identification information and the user characteristic information of the user who browsed the corresponding browsed web page; and

an icon publication means that enables each individual user to publish, via the corresponding user terminal, the publishing user's own icon to other users;

wherein in displaying published icons on the corresponding user terminal in response to each individual user requesting display, where two or more duplicate icons exist which have identical web page identification information and different user identification information, a higher priority is assigned to an icon published by a user who is different than the requesting user and is more similar than others to the requesting user in terms of the user characteristic, and

the published icons are displayed according to the assigned priorities, thereby allowing the requesting user to use the displayed icons as reference information during goods/service purchase.

Owing to the aforementioned features of the goods/services purchase assistance system according to the second aspect of the present invention, where an individual registered user of the portal site uses the user terminal to browse a goods/services sales web page of the website to explore goods/services of interest, icons relating to the above goods/services of interest (relevant icons) selected among all icons published by other users of the portal site are displayed on the user terminal of the browsing user, so that the displayed icons can be used as reference information. In that case, a number of icons are displayed as search results on the user terminal of the browsing user. Where those icons include two or more duplicate icons that have identical web page identification information and different user identification information (each having different icon identification information), an icon published by a user whose user characteristic (for example, preference) is more similar than others to that of the user requesting display of the above relevant icons is selected from among the two or more duplicate icons for preferential display in the search results.

Accordingly, the above user requesting display of the relevant icons can easily learn in what goods/services from the website each of other users having the similar user characteristic as his or her own is interested (past goods/services browsing record), and what goods/services are being recommended by those other users (recommended goods/services). Knowing such facts enables the user requesting display of the relevant icons to avoid spending hours randomly going through a number of web pages within the website in search of the goods/services of interest, and therefore is extraordinarily useful to the same user.

Thus, the goods/services purchase assistance system according to the second aspect of the present invention can assist the user of the portal site to swiftly and easily search for or purchase desired goods or services, even where goods and services of various brands, makers or providers, prices, designs, and the like are spread over a number of goods/services sales web pages in the website. Such capability translates into the ability to provide easy and secure assistance for search or purchase of goods or services by the user utilizing the portal site.

From the standpoint of the operation company of the website in which the goods/services sales web pages are provided, it is possible to promote sales of goods or services on the goods/services sales web pages included in the website simply by obtaining web page browsing history information of individual users utilizing the portal site.

Moreover, since the web page browsing history information of individual users utilizing the portal site can be accumulated in the portal site, each user can integrally manage the browsing history information of different websites through the icons of a single, common format.

(8) In a preferred example of the goods/services purchase assistance system according to the second aspect of the present invention, the user's preference relating to a particular item of goods/services is used as the user characteristic.

(9) In another preferred example of the goods/services purchase assistance system according to the second aspect of the present invention, the user's preference obtained by identifying a plurality of words that appear frequently in the goods/services attribute information of the user and reprioritizing the identified words is used as the user characteristic.

(10) In yet another preferred example of the goods/services purchase assistance system according to the second aspect of the present invention, only the duplicate icon published by a user assigned a highest priority is selectively displayed where two or more duplicate icons are present for display on the user terminal.

(11) In yet another preferred example of the goods/services purchase assistance system according to the second aspect of the present invention, the goods/services attribute information of the icon is updated either at predetermined time intervals, or where the same icon has been selected by any of the users for a predetermined number of times or more.

(12) In yet another preferred example of the goods/services purchase assistance system according to the second aspect of the present invention, each individual user is assigned a dedicated icon display field that displays icons generated from the plurality of websites, and icons associated with the user identification information corresponding to a user other than the user owing the icon display field, in addition to icons associated with the user identification information corresponding to the user owning the icon display field, are displayable in the icon display field.

(13) According to a third aspect of the present invention, a goods/services purchase assistance program is provided. The program assists purchase of goods/services from one or more websites through a portal site upon request from a user terminal, wherein the one or more websites, each including one or more goods/services sales web pages, are browsable from a plurality of user terminals on the portal site via a communication network. The program is characterized by causing a computer to perform the steps of:

storing user identification information assigned to each individual user of the portal site;

generating browsing history information of each individual user by specifying, among the goods/services sales web pages, a browsed web page browsed by the user via the user terminal, and storing the browsing history information in association with the corresponding user identification information;

generating user characteristic information (for example, preference information) that represents a user characteristic of each individual user based on the browsing history information, and storing the user characteristic information in association with the corresponding user identification information;

generating an icon that is specific to the browsed web page corresponding to the browsing history information and contains an image identifying goods/services displayed on the browsed web page, and storing each individual icon with icon identification information assigned thereto,

storing the icon identification information in association with web page identification information (for example, the URL) of the corresponding browsed web page, predetermined goods/services attribute information (such as, for example, the price and the maker or provider) relating to the goods/services displayed on the corresponding browsed web page, and the user identification information and the user characteristic information of the user who browsed the corresponding browsed web page; and

enabling each individual user to publish, via the corresponding user terminal, the publishing user's own icon to other users,

wherein in displaying published icons on the corresponding user terminal in response to each individual user requesting display, where two or more duplicate icons exist which have identical web page identification information and different user identification information, a higher priority is assigned to an icon published by a user who is different than the requesting user and is more similar than others to the requesting user in terms of the user characteristic, and

the published icons are displayed according to the assigned priorities, thereby allowing the requesting user to use the displayed icons as reference information during goods/service purchase.

For the same reasons described above as to the goods/services purchase assistance method according to the first aspect of the present invention, the goods/services purchase assistance program according to the third aspect of the present invention can assist the user of the portal site to swiftly and easily search for or purchase desired goods or services, even where goods and services of various brands, makers or providers, prices, designs, and the like are spread over a number of goods/services sales web pages in the website. Such capability translates into the ability to provide easy and secure assistance for search or purchase of goods or services by the user utilizing the portal site.

From the standpoint of the operation company of the website in which the goods/services sales web pages are provided, it is possible to promote sales of goods or services on the goods/services sales web pages included in the website simply by obtaining web page browsing history information of individual users utilizing the portal site.

Moreover, since the web page browsing history information of individual users utilizing the portal site can be accumulated in the portal site, each user can integrally manage the browsing history information of different websites through the icons of a single, common format.

(14) In a preferred example of the goods/services purchase assistance program according to the third aspect of the present invention, the user's preference relating to a particular item of goods/services is used as the user characteristic.

(15) In another preferred example of the goods/services purchase assistance program according to the third aspect of the present invention, the user's preference obtained by identifying a plurality of words that appear frequently in the goods/services attribute information of the user and reprioritizing the identified words is used as the user characteristic.

(16) In yet another preferred example of the goods/services purchase assistance program according to the third aspect of the present invention, only the duplicate icon published by a user assigned a highest priority is selectively displayed where two or more duplicate icons are present for display on the user terminal.

(17) In yet another preferred example of the goods/services purchase assistance program according to the third aspect of the present invention, the goods/services attribute information of the icon is updated either at predetermined time intervals, or where the same icon has been selected by any of the users for a predetermined number of times or more.

(18) In yet another preferred example of the goods/services purchase assistance program according to the third aspect of the present invention, each individual user is assigned a dedicated icon display field that displays icons generated from the plurality of websites, and icons associated with the user identification information corresponding to a user other than the user owing the icon display field, in addition to icons associated with the user identification information corresponding to the user owning the icon display field, are displayable in the icon display field.

### (Definition of Terms)

Listed below are the definitions of terms as used in the present invention depicted above.

The term “portal site” refers to a website established on a communication network, such as the Internet, which provides a starting point or a gateway to access one or more websites provided on the communication network, so as to facilitate use of various services and information provided by those websites. The term “portal site” includes one or more websites that can be accessed via the “portal site.”

The term “website” refers to a group of web pages that are published on a communication network, such as the Internet, or a site on the communication network where the group of web pages are located. The “website” normally has a specific domain name assigned thereto.

The term “web page” refers to each of the web pages published on a given website.

The term “goods/services sales web page (sales page)” refers to a “web page” on which at least an image of goods or services for sale (usually a single goods or services item or a set of such items) is displayed, and which has the ability to process a decision of a “user” to purchase the goods or services displayed on the page. For example, the term “goods/services sales web page (sales page)” may apply to a “web page” that includes an image of goods or services for sale as well as a code to display an “Add to Cart” button, “Reserve” button, or the like.

The term “web page identification information” refers to any information for distinguishing one “web page” from another, and may include, for example, the URL (Uniform Resource Locator) of a web page. The “web page identification information” generally consists of numerical values, letters, symbols, or a combination thereof, although the term is not limited to those described herein and any information that allows for distinction among “web pages” can be used.

The term “network” refers to a state or mechanism in which a plurality of computers and information communication devices are connected to each other based on a common telecommunications standard to enable mutual exchanges of information. Examples include the Internet and other computer networks. Accordingly, the term “communication network” refers to a network for performing communication.

The term “user” refers to a user registered to a “portal site” to use a service or information provided by the “portal site.” The “user” can freely access one or more “websites” included in the “portal site” to search for and/or purchase goods or services displayed on a goods/services sales “web page” included in the “website.”

The term “user terminal” refers to an information communication terminal owned by a “user” of a “portal site,” whereby any “website” included in a “portal site” may be accessed via a “communication network” to browse a given “web page” included in the “website,” and to search for and/or purchase goods or services displayed on the “web page.”

The term “user identification information” refers to any information for distinguishing among “users” of the portal site, which may include, for example, a user ID used in the portal site. The “user identification information” generally consists of numerical values, letters, symbols, or a combination thereof, although the term is not limited to those described herein and any information that allows for distinction among “users” can be used.

The term “user characteristic” refers to a characteristic that belongs to an individual “user” of a “portal site.” For example, the term may apply to the individual user's preference relating to particular goods or services. However, the term is not limited to preference” and any characteristic that belongs to the individual “user” may suffice. For example, the “user characteristics” may include a behavioral characteristic (taste in behavior) particular to the individual “user.”

The term “user characteristics information” refers to information that indicates the “user characteristics” of an individual “user” of a “portal site,” that is, information that describes the “user characteristics.” For example, the term may apply to information indicating “preference” where a “user characteristic” is the “preference” of the individual “user” pertaining to particular goods or services.

The term “browsing history information” refers to information that indicates a history of “websites” browsed by the “user” of the “portal site.” The “browsing history information” generally consists of numerical values, letters, symbols, or a combination thereof, although the term is not limited to those described herein and any information indicative of a browsing history can be used.

The term “browsed page” refers to a “web page” that has been browsed by a given “user” of a “portal site.”

The term “goods/services attribute” refers to any attribute of goods or services, which may include, for example, the price of the goods or services, the maker or provider, the type and target of the goods or services, and the like.

The term “goods/services attribute information” refers to information that indicates the “goods/services attribute.” The “goods/services attribute information” generally consists of numerical values, letters, symbols, or a combination thereof, although the term is not limited to those described herein and any information indicative of a “goods/services attribute” can be used.

The term “image identifying goods/services” refers to an image for identifying goods or services displayed on a web page, which may typically include an image of sample picture or external looks of the goods or services displayed on the web page. In case a plurality of images are selectively displayed on the “sales page,” an image prescribed for display in the absence of any designation, or “default image,” is preferably selected for use in an “icon.”

The term “icon” refers to an expression of particular goods or services using an “image identifying goods/services,” so as to distinguish such goods or services from others and to communicate the content of the same to other individuals. Although the “icon” may consist of the “image identifying goods/services” alone, the term typically includes “goods/services attribute information” indicative of the particular goods or services (e.g., the price of the goods or services, the maker or provider, the type and target of the goods or services, and the like) in addition to the “image identifying goods/services.” When displayed on the “user terminal,” the “icon” can be resized (scaled down) according to the size of display area and the total number of “icons” displayed.

The term “icon identification information” refers to any information for distinguishing one “icon” from another, which may include, for example, an icon ID used in the portal site. The “icon identification information” generally consists of numerical values, letters, symbols, or a combination thereof, although the term is not limited to those described herein.

### Advantageous Effects of the Invention

Advantageous effects of the goods/services purchase assistance method according to the first aspect of the present invention, the goods/services purchase assistance system according to the second aspect of the present invention, and the goods/services purchase assistance program according to the third aspect of the present invention include:

(a) the ability to assist the user of the portal site to swiftly and easily search for or purchase desired goods or services, even where goods and services of various brands, makers or providers, prices, designs, and the like are spread over a number of goods/services sales web pages in single or multiple websites;

(b) the ability to provide easy and secure assistance for search or purchase of goods or services by the user utilizing the portal site;

(c) the ability to promote sales of goods or services on the goods/services sales web pages included in the single or multiple websites simply by obtaining web page browsing history information of individual users utilizing the portal site; and

(d) the ability to allow each user to integrally manage the browsing history information of different websites accumulated in the portal site through icons of a single, common format.

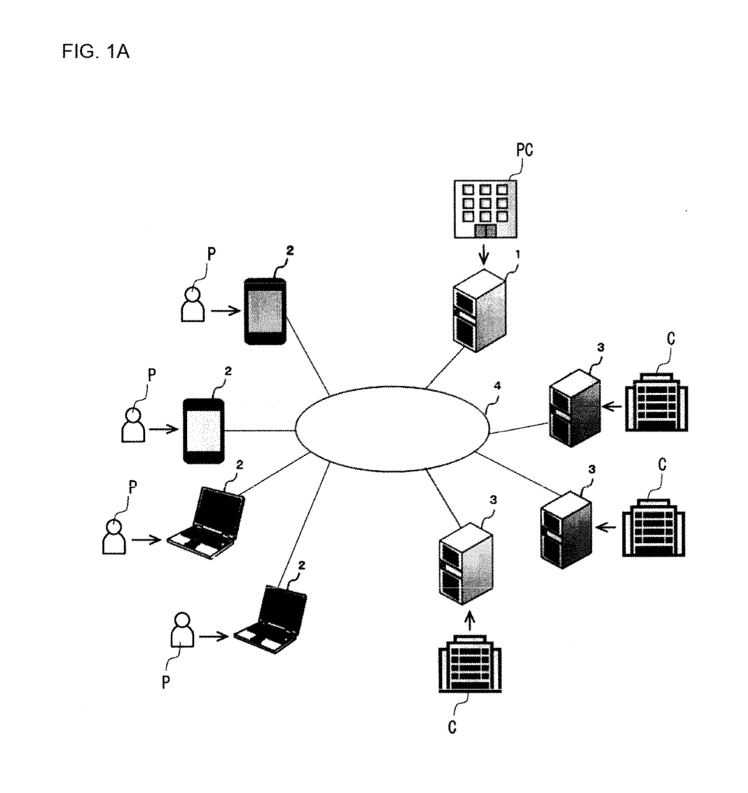

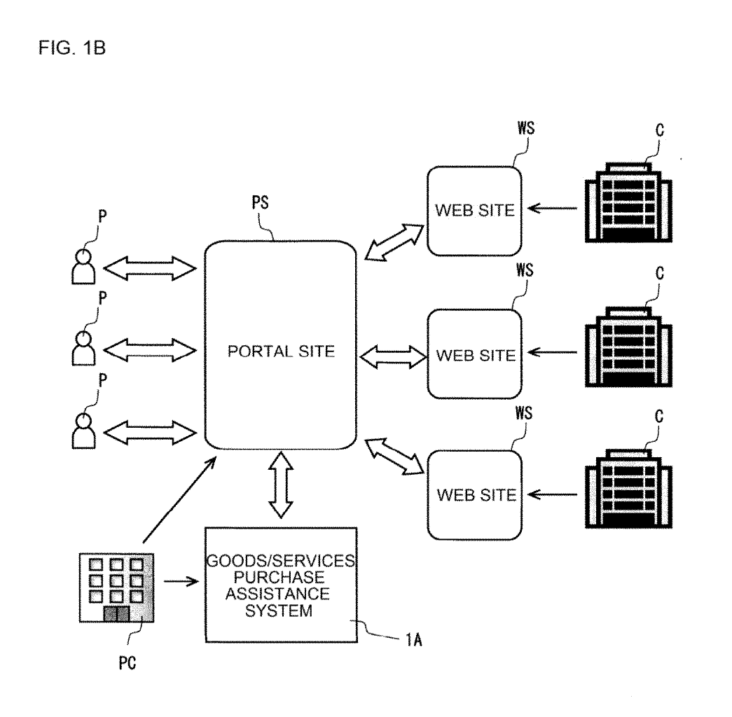

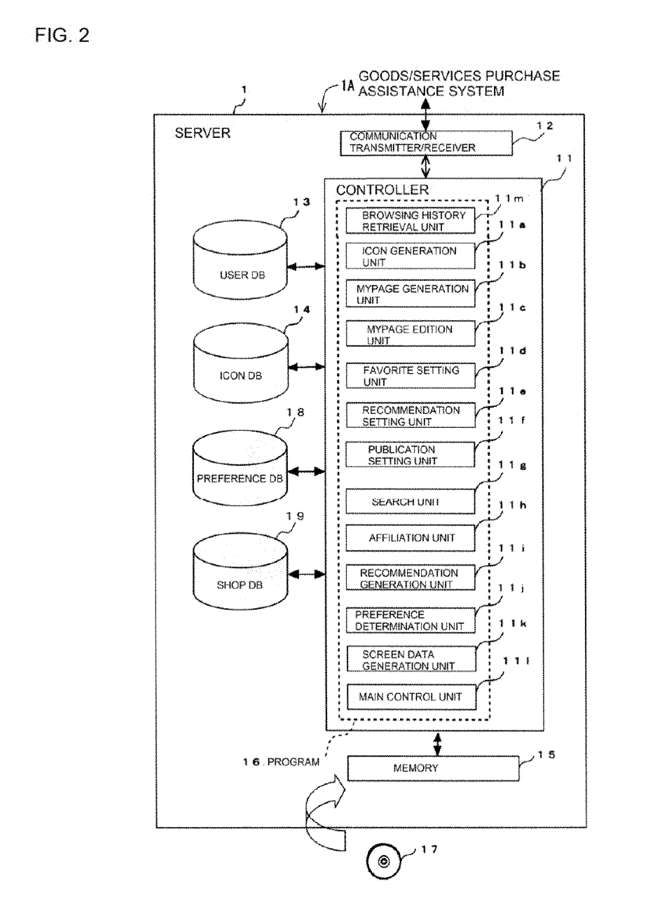

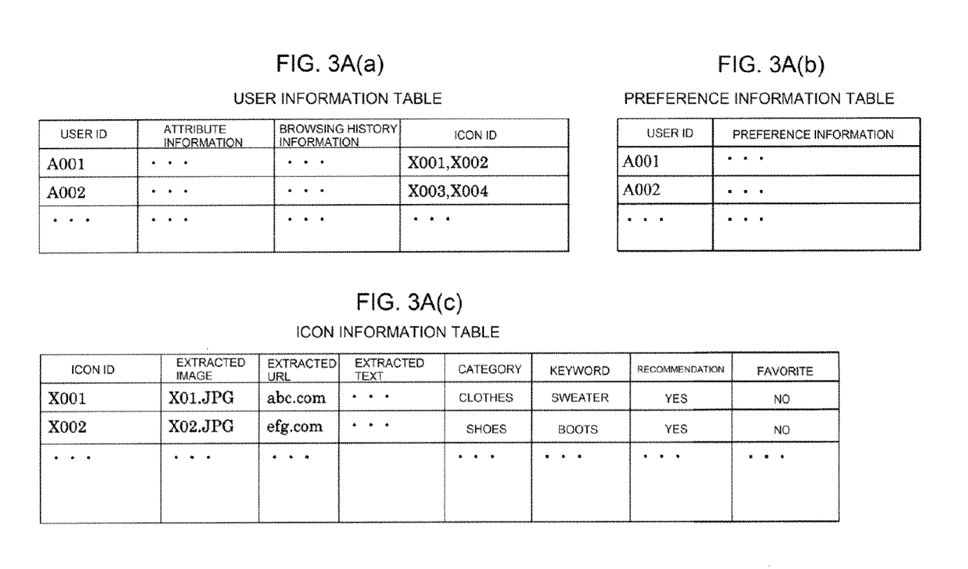

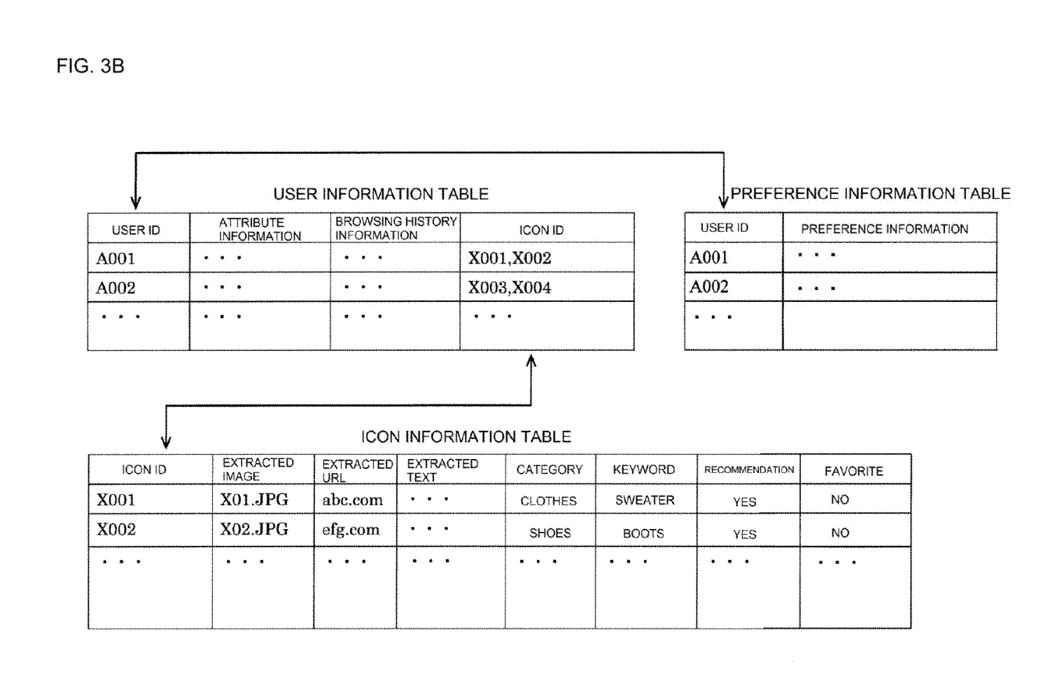

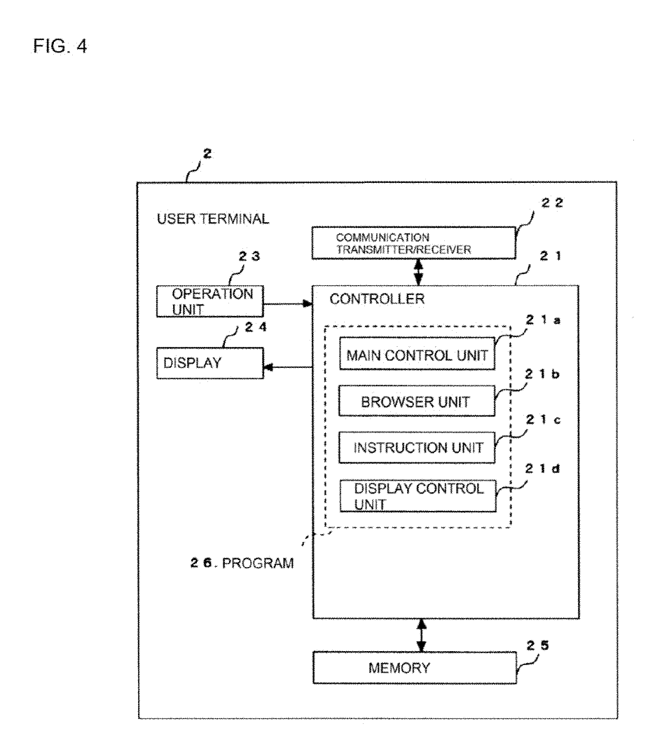

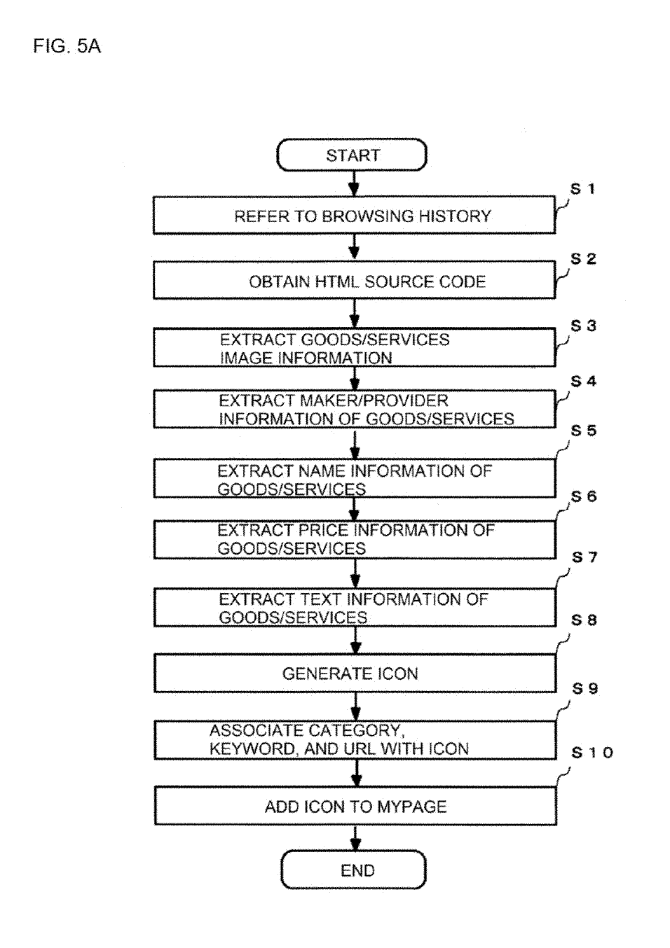

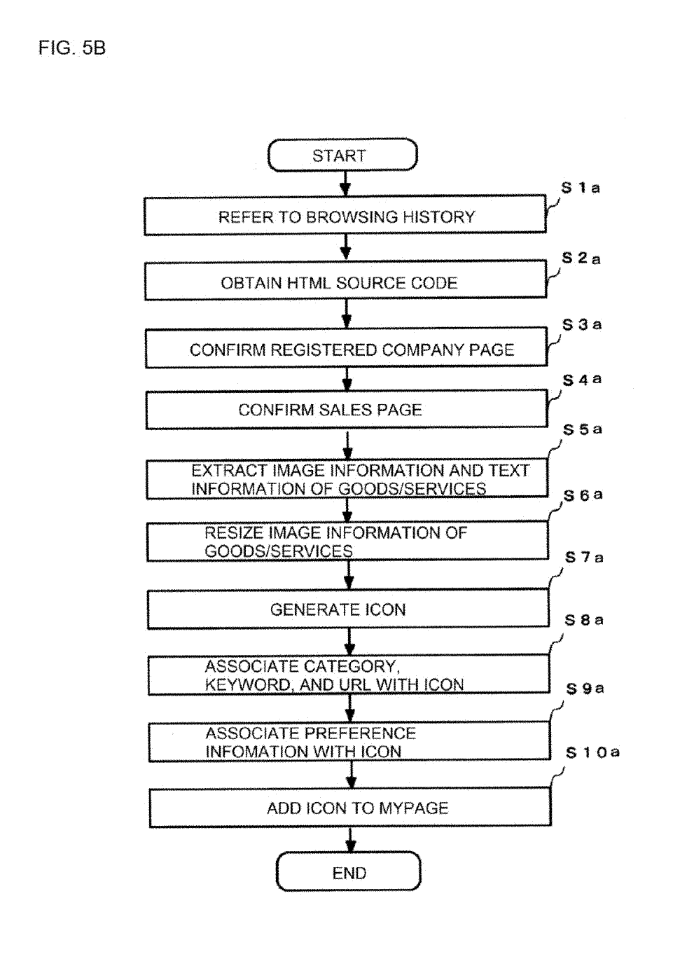

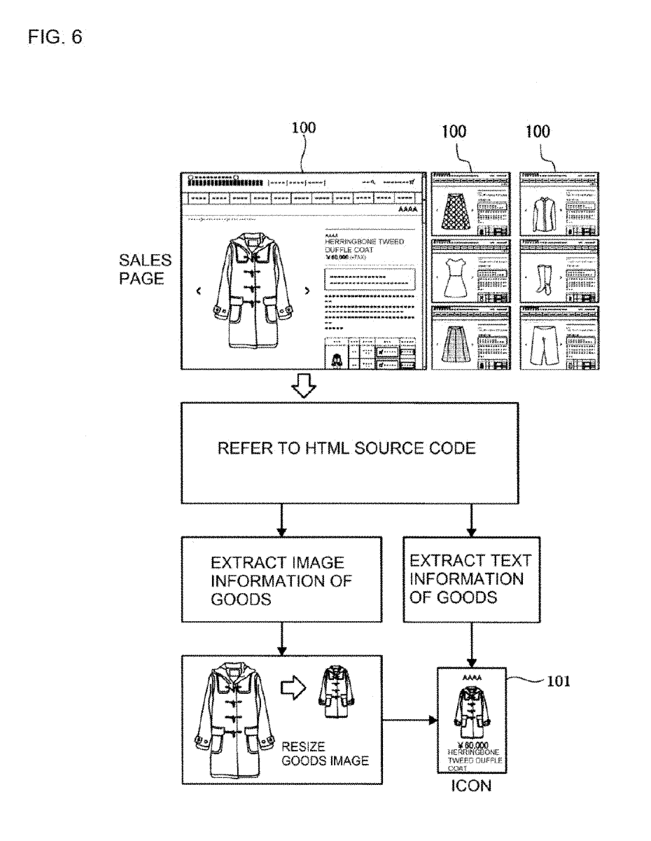

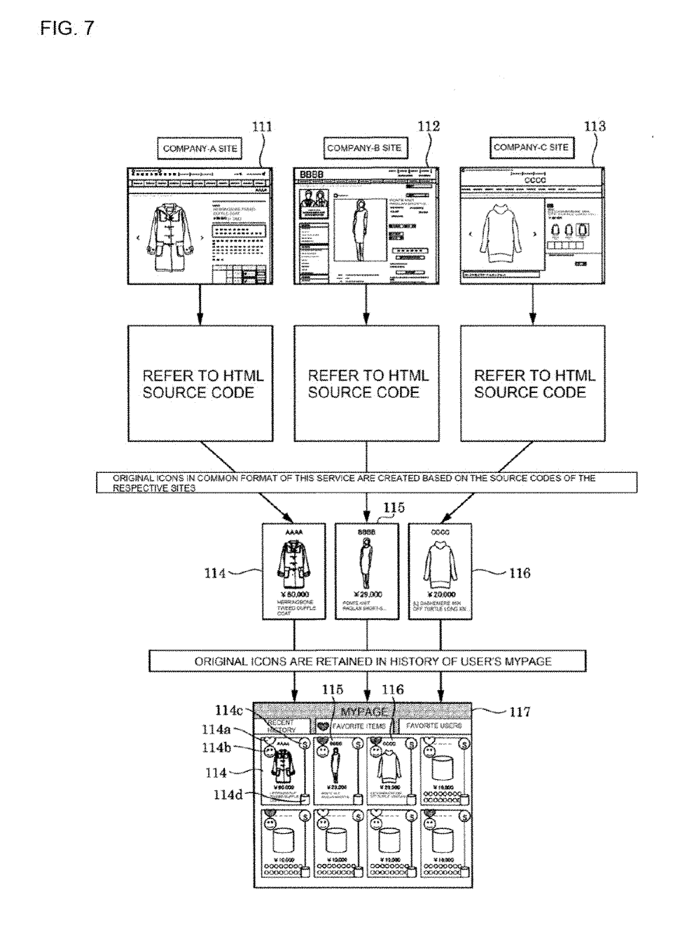

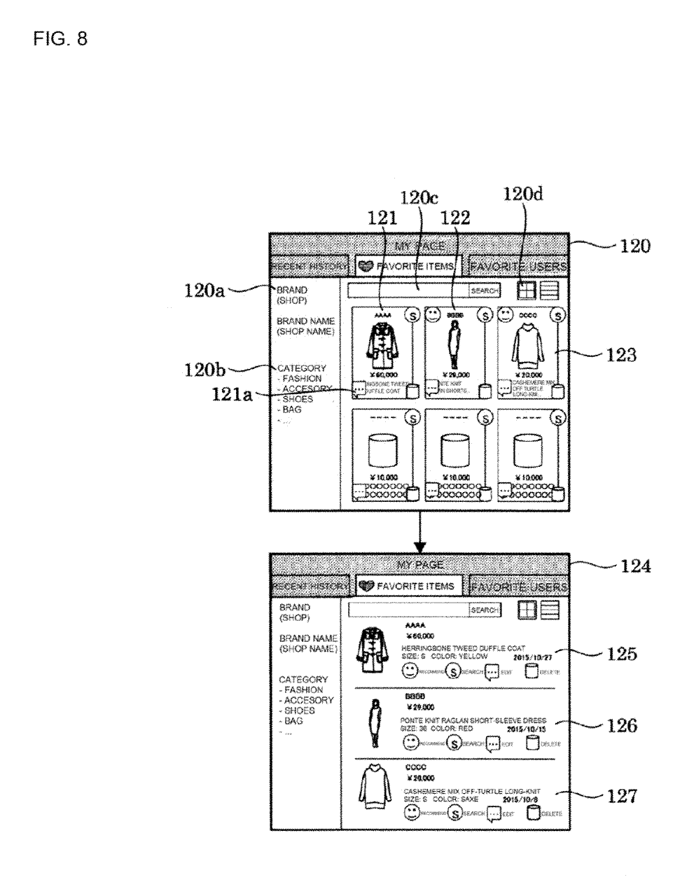

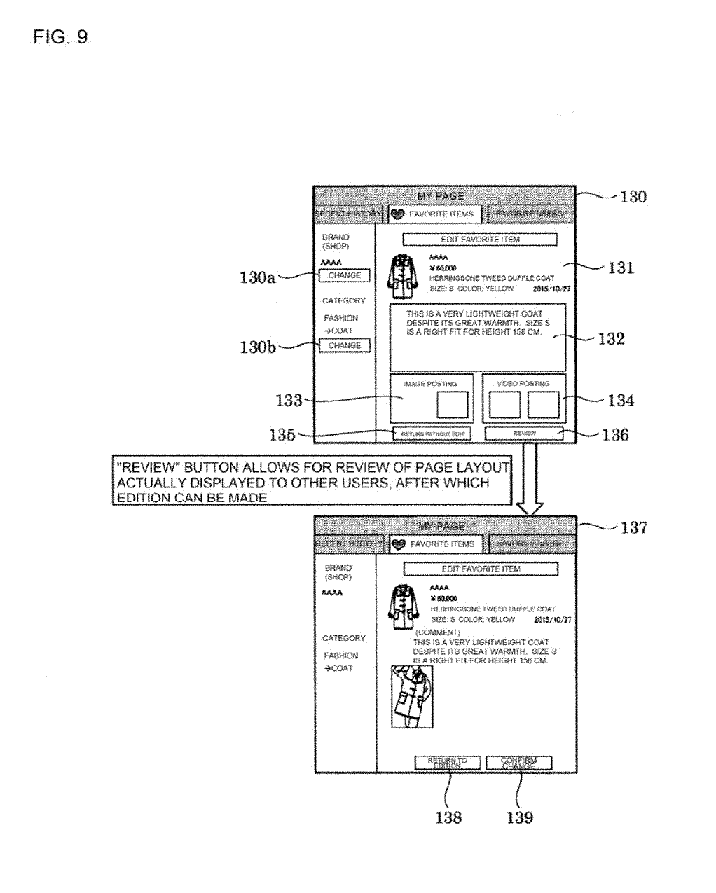

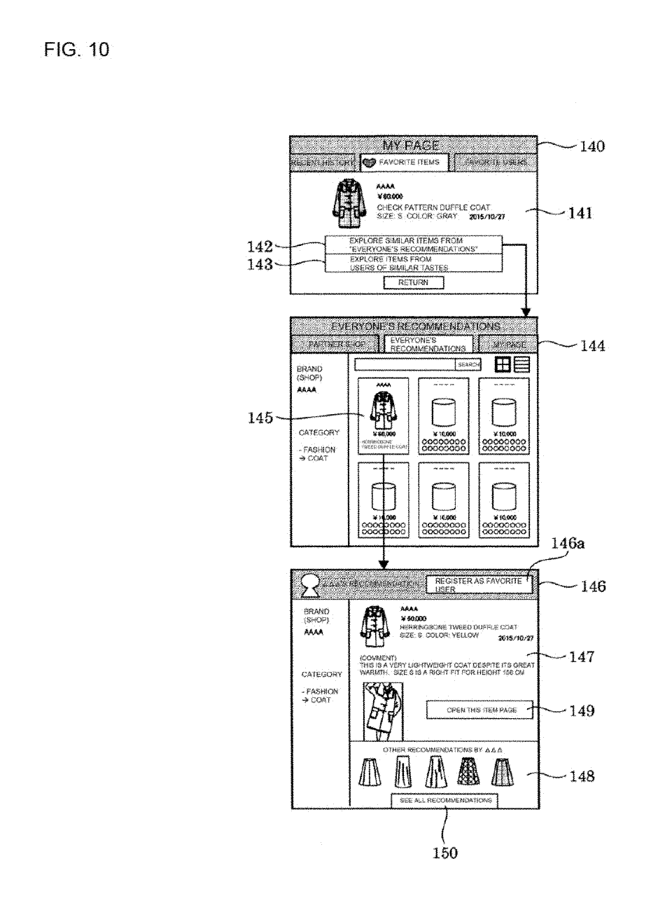

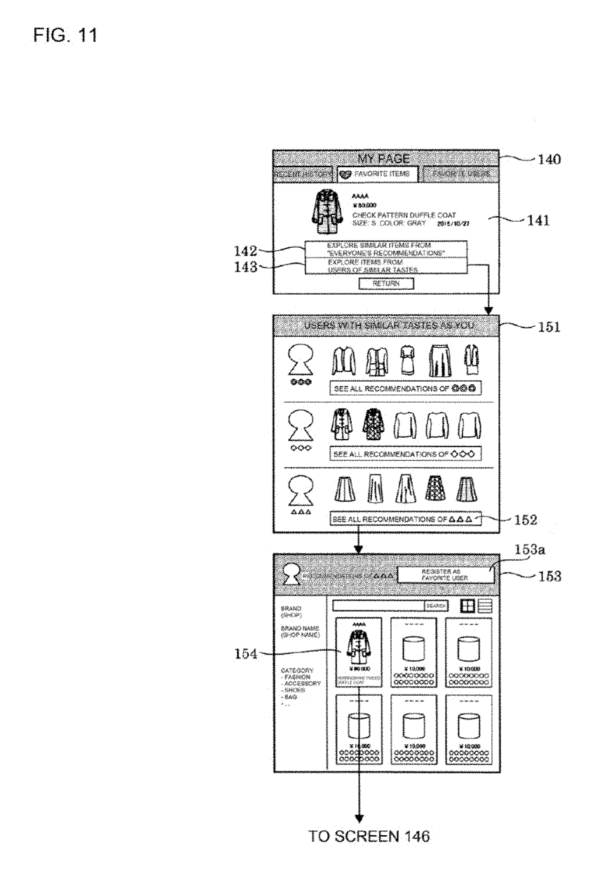

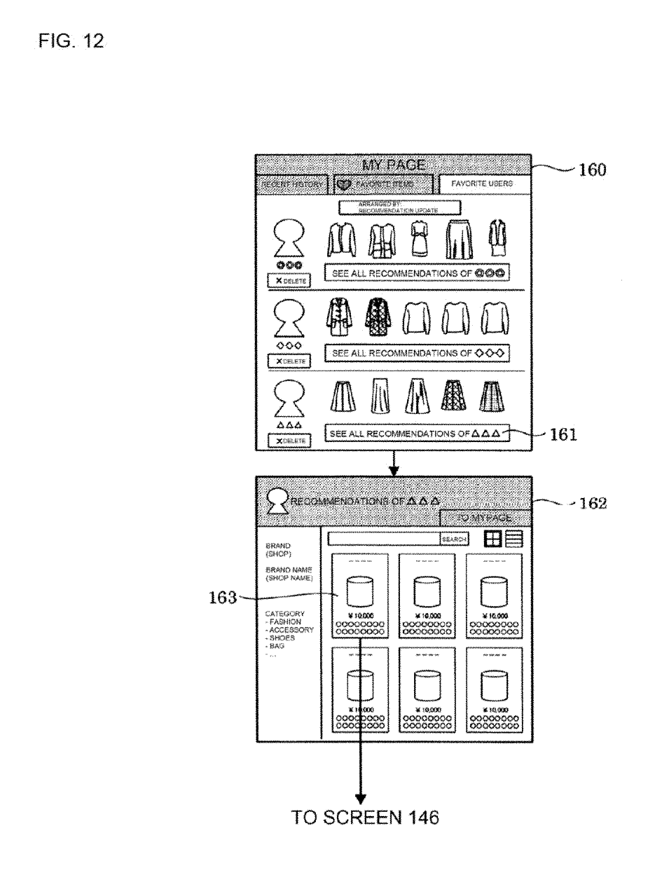

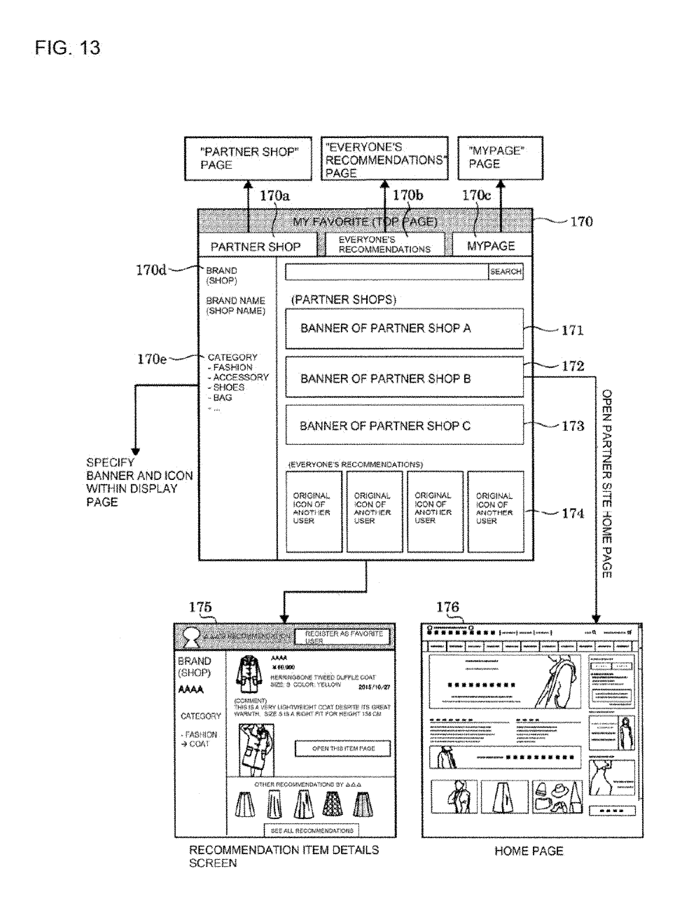

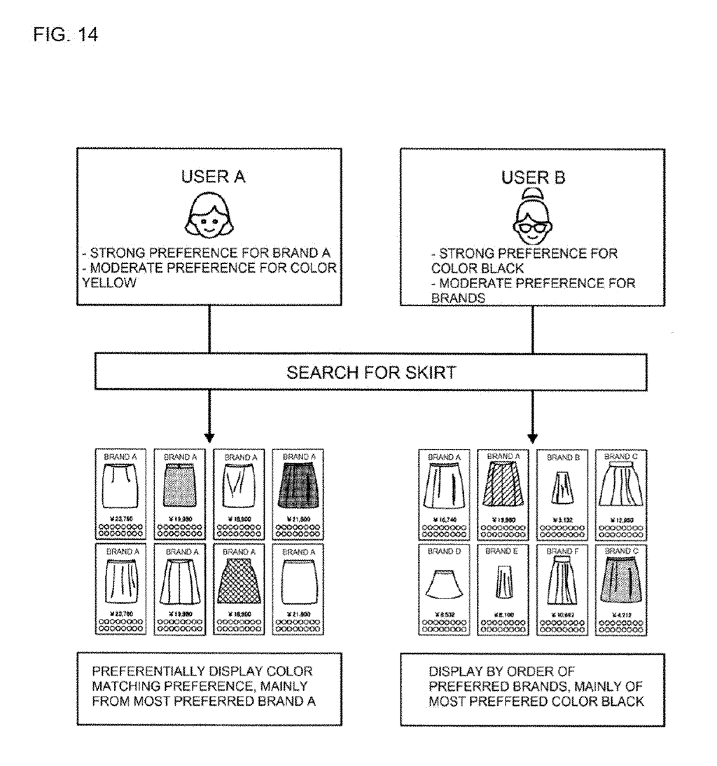

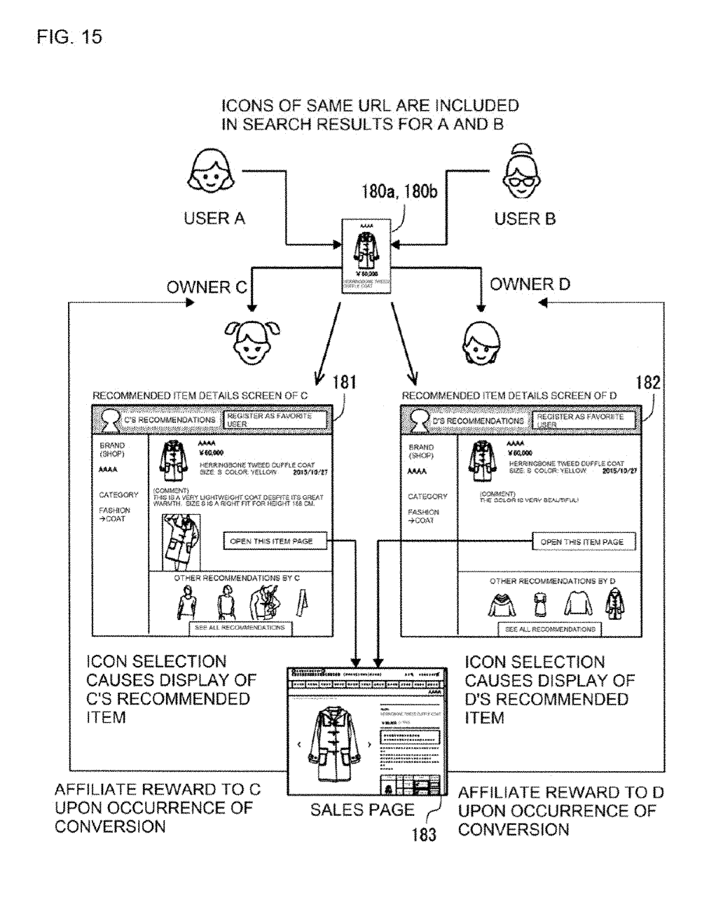

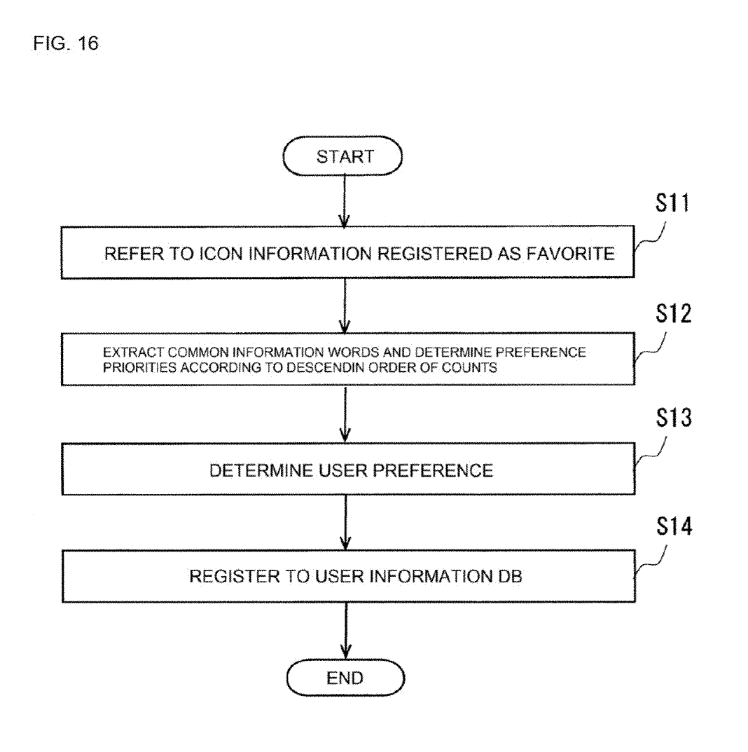

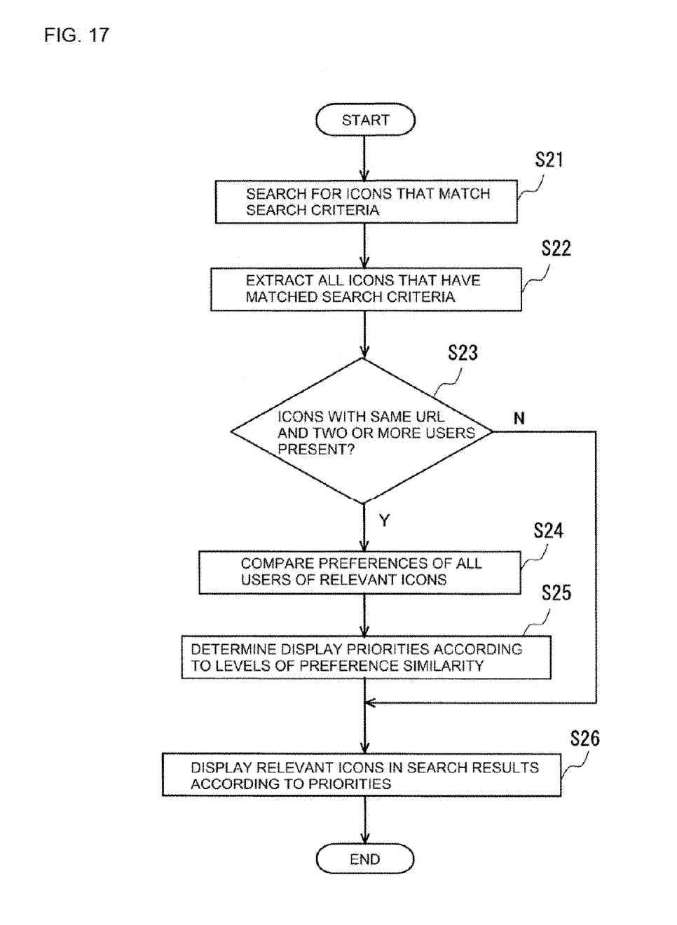

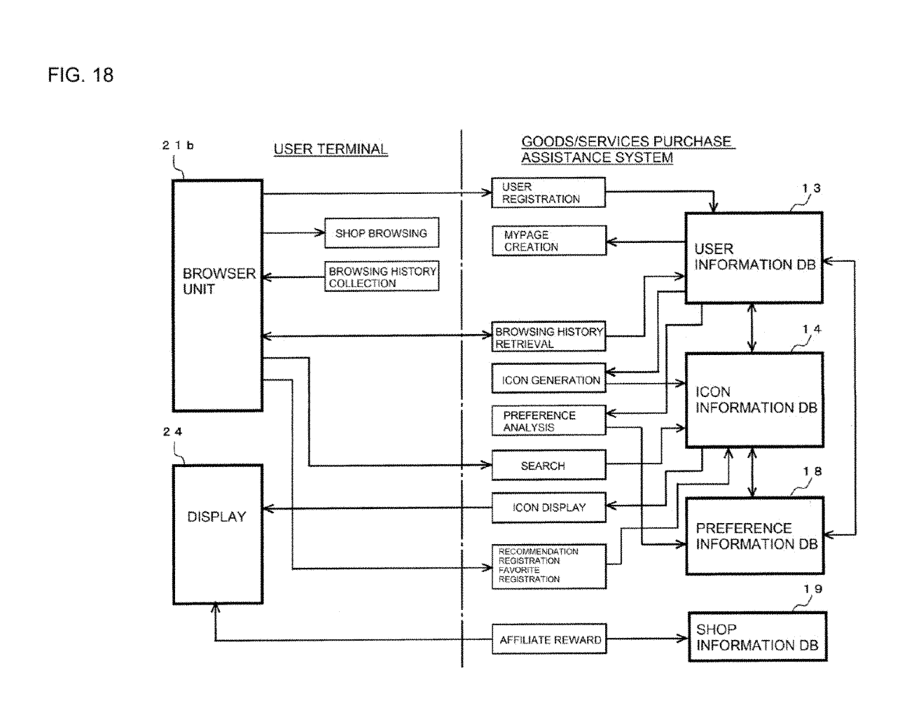

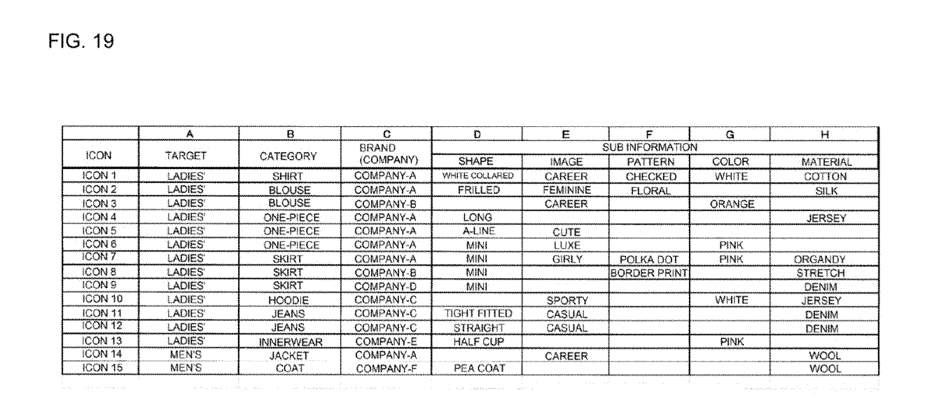

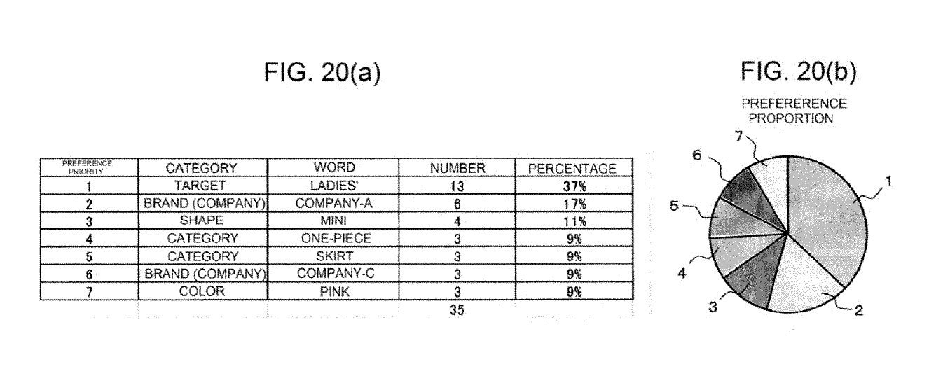

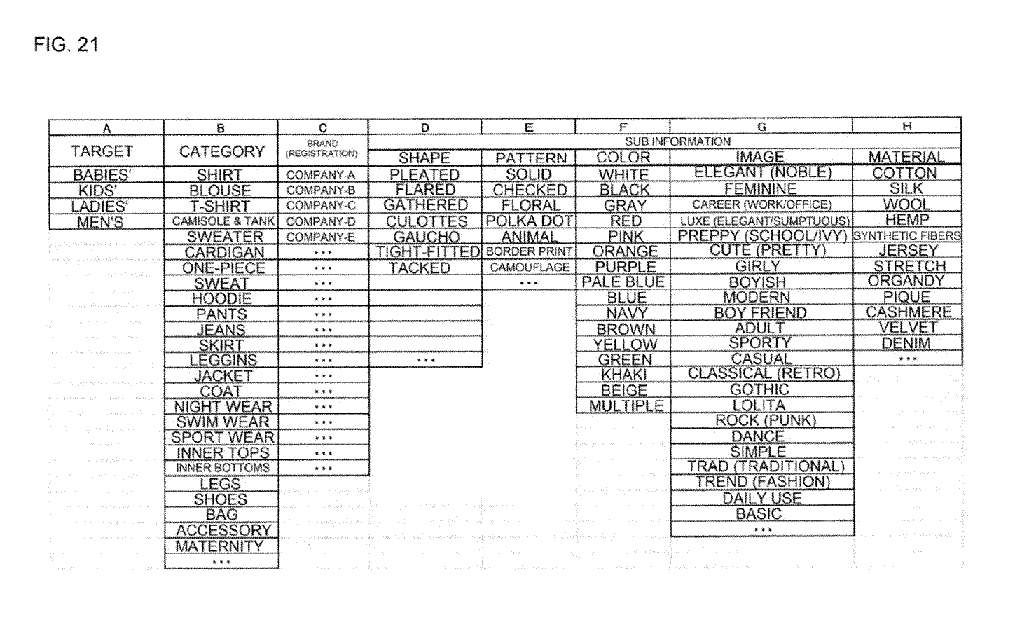

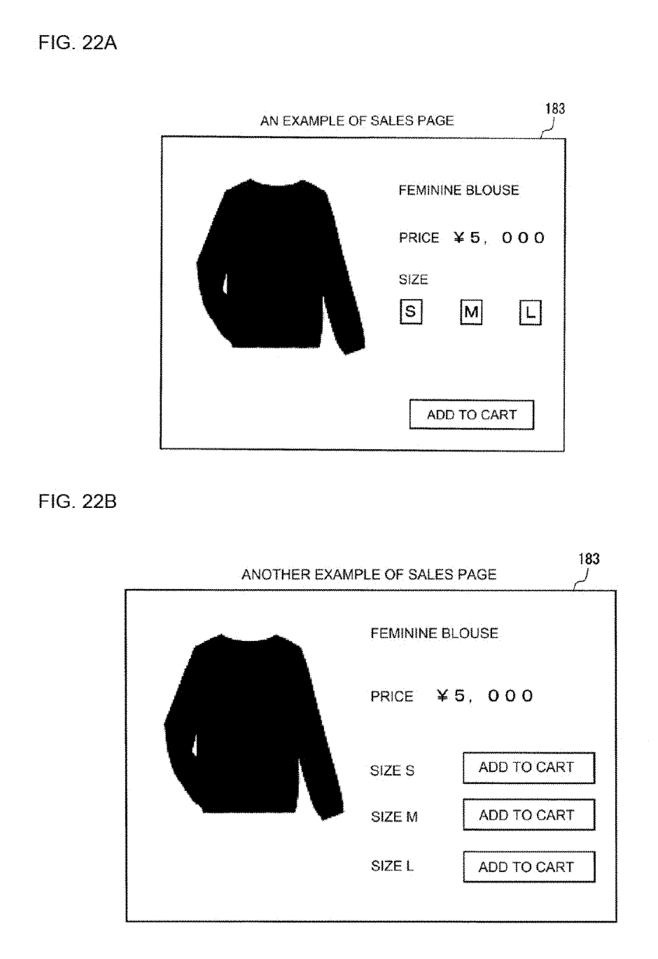

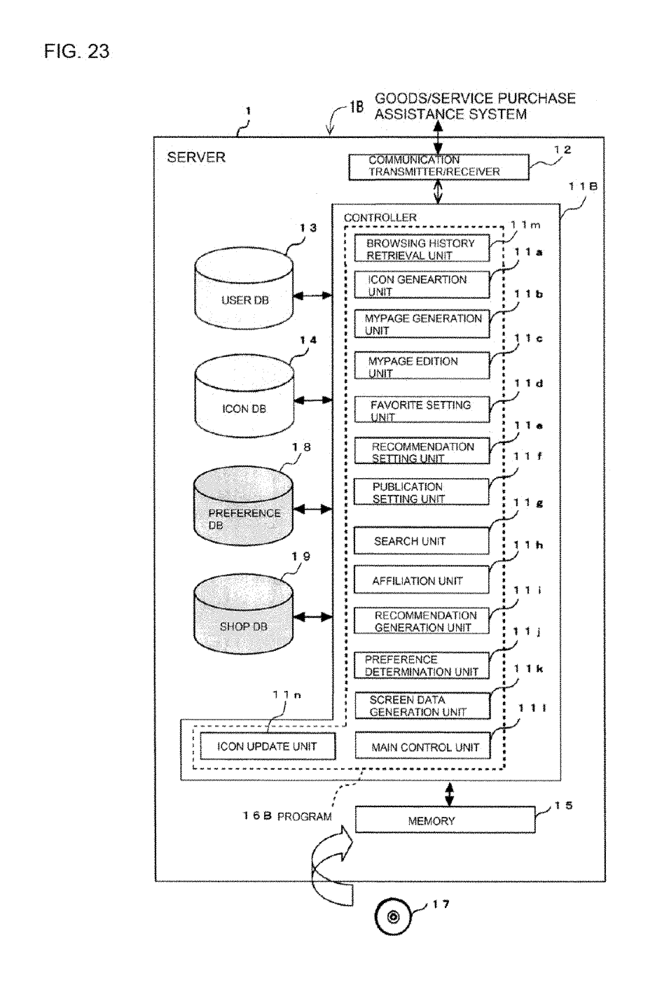

### BRIEF DESCRIPTION OF DRAWINGS

[FIG. 1A] A conceptual diagram that describes an application of a goods/services purchase assistance system according to a first embodiment of the present invention.

[FIG. 1B] A conceptual diagram that describes a relationship among the goods/services purchase assistance system according to the first embodiment of the present invention, a portal site in which the goods/services purchase assistance system is provided and an operation company of the same, as well as users of the portal site, websites provided in the portal site, and operation companies of the websites.

[FIG. 2] A block diagram of the goods/services purchase assistance system (server) according to the first embodiment of the present invention.

[FIG. 3A] (a) is a configuration diagram of a user information DB of the goods/services purchase assistance system of FIG. 2, (b) is a configuration diagram of an icon information DB of the same system, and (c) is a configuration diagram of a preference information DB of the same system.

[FIG. 3B] A conceptual diagram that describes an association among the user information DB, the icon information DB, and the preference information DB described in FIG. 3A.

[FIG. 4] A block diagram of a user terminal for use with the goods/services purchase assistance system of FIG. 2.

[FIG. 5A] A flowchart that describes an icon generation procedure in the goods/services purchase assistance system of FIG. 2.

[FIG. 5B] A flowchart that describes another icon generation procedure in the goods/services purchase assistance system of FIG. 2.

[FIG. 6] A conceptual diagram that describes an icon generation process in the goods/services purchase assistance system of FIG. 2.

[FIG. 7] A conceptual diagram that describes a process through which an icon is registered to a MyPage in the goods/services purchase assistance system of FIG. 2.

[FIG. 8] A conceptual diagram that describes a MyPage favorite item page in the goods/services purchase assistance system of FIG. 2.

[FIG. 9] A conceptual diagram that describes edition of the favorite item page in the goods/services purchase assistance system of FIG. 2.

[FIG. 10] A conceptual diagram that describes a search of items (goods) via an icon in the goods/services purchase assistance system of FIG. 2.

[FIG. 11] A conceptual diagram that describes a search of items (goods) via an icon in the goods/services purchase assistance system of FIG. 2.

[FIG. 12] A diagram that describes a transition from a favorite user page to a details screen in the goods/services purchase assistance system of FIG. 2.

[FIG. 13] A diagram that describes transitions from a portal site home page in the goods/services purchase assistance system of FIG. 2.

[FIG. 14] A conceptual diagram that describes a difference in items (goods) displayed in search results (icon individualization) in the goods/services purchase assistance system of FIG. 2.

[FIG. 15] A conceptual diagram for describing characteristics of the icons used in the goods/services purchase assistance system of FIG. 2.

[FIG. 16] A flowchart that describes a user preference analysis procedure in the goods/services purchase assistance system of FIG. 2.

[FIG. 17] A flowchart that describes a procedure to display an icon that matches search criteria in the goods/services purchase assistance system of FIG. 2.

[FIG. 18] An explanatory diagram summarizing overall operation of the goods/services purchase assistance system of FIG. 2.

[FIG. 19] A table that describes an example of user preference analysis process in the goods/services purchase assistance system of FIG. 2.

[FIG. 20] (a) is a table used in the preference analysis process in the goods/services purchase assistance system of FIG. 2, and (b) is a pie chart describing proportions of words, as derived from the table (a).

[FIG. 21] A table that describes a specific example of combination of determination criteria and words for use in the preference analysis procedure in the goods/services purchase assistance system of FIG. 2.

[FIG. 22A] An explanatory diagram that describes an exemplary sales page used in the goods/services purchase assistance system (server) of FIG. 2.

[FIG. 22B] An explanatory diagram that describes another exemplary sales page used in the goods/services purchase assistance system (server) of FIG. 2.

[FIG. 23] A block diagram of the goods/services purchase assistance system (server) according to a second embodiment of the present invention.

### MODES FOR CARRYING OUT THE INVENTION

Preferred embodiments of the present invention will be now described with reference to the drawings.

### First Embodiment

FIG. 1A describes an application of a goods/services purchase assistance system 1A according to a first embodiment of the present invention. FIG. 1B describes a relationship among the goods/services purchase assistance system 1A, a portal site PS and websites WS associated with the system 1A, an operation company PC of the portal site PS, and operation companies C of the respective websites WS, and registered users P of the portal site PS.

As depicted in FIGS. 1A and 1B, the goods/services purchase assistance system 1A according to the first embodiment of the present invention, as well as the portal site PS cooperatively working with the system 1A, are built on a server 1. The server 1 and a plurality of information terminals 2 (hereinafter, also referred to as “user terminals”) of the registered users P of the portal site PS are connected to a communication network 4 (hereinafter, also referred to as “network”), such as the Internet, so that the server 1 and the information terminals 2 are mutually communicable via the network 4. A plurality of web servers 3 are also connected to the network 4. In addition to be able to communicate with each other, the server 1 and the plurality of user terminals 2 can also communicate with the web servers 3 via the network 4.

Each web server 3 is managed and operated by a particular company C, and provides a specific web service to all the users of the network 4 (including all the registered users P of the portal site PS) by establishing a corresponding website WS on the network 4. Any of these websites WS includes a plurality of web pages for selling particular goods and services (goods/services sales page) (hereinafter, also referred to as “sales page”).

Meanwhile, the server 1 is managed and operated by the particular company PC, and establishes on the network 4 the portal site PS which provides a starting point or a gateway to access the plurality of websites WS described above. The server 1 provides the users P registered to the portal site PS with a browsing history management service for facilitating management of the individual user's website browsing history (details will be described later). The registered users P of the portal site PS may use the browsing history management service via the network 4 for free by using their own user terminals 2.

The portal site operation company PC provides all the registered users P of the portal site PS with the above-described browsing history management service as a measure to assist purchase of goods and services at each website. It is possible for the portal site operation company PC to individually contract with the website provider company C to develop a further service, whereby a predetermined affiliate reward is collected from the company C where the user P makes a purchase, reservation, or the like of the goods/services in the goods/services sales page of the company C through the portal site PS, so that the reward is distributed to the registered user P who made the contribution.

In FIG. 1, the server 1, or more specifically, the goods/services purchase assistance system 1A implemented by the server 1 obtains and manages information (browsing history information) that indicates a history of the registered user P (hereinafter, also simply referred to as “user”) of the portal site PS browsing any web page of the above-described websites PS via the user's own user terminal 2. The goods/services purchase assistance system 1A generates an icon specific to the user P based on the browsing history information, and enables search and sharing of the browsing history information via the icon. The user P may have a MyPage in the portal site PS for browsing and/or managing the user's own icons. Whenever the user P browses the website WS via the portal site PS, such browsing history information of the user P is accumulated in the goods/services purchase assistance system 1A, and a group of icons generated based on the browsing history information is registered in the MyPage of the user P.

For example, where a web page browsed by the user P concerns fashions and apparels, an icon in which data or particulars of goods appearing on the web page, including goods image, maker name, goods name, and price, are laid out is automatically generated and stored by the goods/services purchase assistance system 1A. Accordingly, by simply moving to the individual user's MyPage from the web page of the portal site PS, the user P can easily check out the goods of the website WS which he or she has previously browsed. Moreover, publication of all the icons registered in the MyPage of the portal site PS may be selectively permitted or denied to other registered users P (as described later). Therefore, if such publication is “permitted,” registered information relating to those icons (goods-related information such as, for example, goods images on the icons, maker names, goods names, and prices) is published to other registered users P, that is, the registered information relating to the icons may be shared with other registered users P. Further, as will be later described, since the registered information relating to the icons is cumulatively stored in database of the goods/services purchase assistance system 1A, it is also possible to search for registered information via these icons.

FIG. 2 describes a detailed configuration of the goods/services purchase assistance system 1A (server 1) according to the first embodiment of the present invention.

As described in FIG. 2, the goods/services purchase assistance system 1A (server 1) includes a controller 11; a communication transmitter/receiver 12 that controls communications with an external device; a user information database (user information DB) 13 that stores registered user information of the registered user P of the portal site PS; an icon information database (icon information DB) 14 that stores icon information of the registered user P; a memory 15 that stores a program 16; a preference information database (preference information DB) 18 that stores preference information; and a shop information database (shop information DB) 19 that stores shop information.

The controller 11 is connected to the communication transmitter/receiver 12, the user information DB 13, the icon information DB 14, the memory 15, the preference information DB 18, and the shop information DB 19, and can mutually send and receive required signals and information therewith. The memory 15 also stores the program 16 recorded in a recording medium (for example, a CD-ROM or a DVD-ROM) 17. Thus, by reading and executing the program 16 stored in the memory 15, the controller 11 functions as an icon generation unit 11a, a MyPage generation unit 11b, a MyPage edition unit 11c, a favorite setting unit 11d, a recommendation setting unit 11e, a publication setting unit 11f, a search unit 11g, an affiliation unit 11h, a recommendation generation unit 11i, a preference determination unit 11j, a screen data generation unit 11k, a main control unit 11l, and a browsing history retrieval unit 11m. Additionally, the controller 11 consists of hardware such as a CPU, and software such as the program 16 which controls the hardware. The memory 15 comprises a computer memory, a HDD, and the like. The memory 15 stores the program 16 as mentioned earlier, and provides a work area upon execution of the program 16.

The communication transmitter/receiver 12 is a communication interface and communicates with the user terminals 2 and the web servers 3 and 5 via the network 4.

The user information DB 13 stores user information relating to the registered users P in a table format, as depicted in FIG. 3A(a). This table is referred to as a “user information table.” In the present example, each registered user P is assigned a specific user ID which is the user identification information. Further, for each user ID, attribute information of the corresponding user P (such as, for example, user name, birth date, residence address, e-mail address, and gender), browsing history information of the corresponding web page, and an icon ID assigned to each of a plurality of icons generated based on the browsing history information are stored while associated with each other. Specific examples of the user attribute information include information such as User ID: A001; Name: Taro YAMADA; Gender: Male; E-mail address: t-yamada@xyz.jp, User ID: A002; Name: Hanako YAMADA; Gender: Female; E-mail address: h-yamada@xyz.jp, etc. The icon ID is specific identification information assigned to each icon. The user attribute information and the browsing history information are each provided in one-to-one correspondence with each user ID. Contrarily, the icon IDs are provided in many-to-one correspondence with each user ID since multiple duplicate icons may exist for each user P. These mutually associated items of information are saved in the user information table, as shown in FIG. 3(a), and the user information table is stored in the user information DB 13. However, the present information is not limited to the specific examples depicted herein.

The icon information DB 14 stores information relating to the icons in a table format, as depicted in FIG. 3A(b). This table is referred to as an “icon information table.” In the present example, each of the plurality of generated and stored icons is assigned a specific icon ID which is the icon identification information. Further, for each icon ID, the file name of an image (image identifying goods or services, hereinafter also referred to as “goods/services identification image”) that appears on the display of the user terminal 2 in the form of the corresponding icon, the URL (Uniform Source Locator) of the web page (sales page) displaying the goods or services from which the icon is derived, predetermined data (extracted data) extracted from all the information relating to the particular goods or services, the category to which the goods or services belong, and a keyword assigned to the goods or services are stored while associated with each other. The file name of the goods/services identification image, the URL, the extracted data, the category, and the keyword are each provided in one-to-one correspondence with each icon ID. Furthermore, for each icon ID, presence or absence of recommendation (recommend) of the goods or services relating to the corresponding icon, and presence or absence of favorite setting as to the goods or services relating to the corresponding icon are stored while associated with each other. The presence or absence of recommendation (recommend) and the presence or absence of favorite setting are provided in one-to-one correspondence with each icon ID as well. These mutually associated items of information are saved in the icon information table, as shown in FIG. 3A(b), and the icon information table is stored in the icon information DB 14. Additionally, the above-described extracted data may include, for example, maker names or service provider names of the goods or services, goods or services names, prices, colors, sizes (free, S, M, L, LL, etc.), shapes (long sleeve/short sleeve, etc.), types (spring-summer clothes/winter clothes, etc.), men's or ladies' category, target (babies, children, teens, youth, adults, seniors, etc.), and the like. In particular, the extracted data described above constitutes a part of the registered information. However, the present information is not limited to the specific examples depicted herein.

The preference information DB 18 stores preference information relating to the registered users P in a table format, as depicted in FIG. 3A(c). This table is referred to as a “preference information table.” In the present example, the preference information of the corresponding user P is stored while associated with each user ID. The preference information comprises information indicating which goods or services the corresponding user P tends to prefer. For example, where it relates to coats, the preference information indicates which brand, shape, and color are preferred. The preference information is automatically derived by analyzing the browsing history information of the user P. The preference information table is stored in the preference information DB 18.

The shop information DB 19 stores information (shop information) in a table format, not shown, similar to that in which the user information table is provided, relating to the companies that open their goods/services sales websites WS (web shops) browsable from the portal site PS (that is, the companies registered to the portal site PS). This table is referred to as a “shop information table.” For example, for each shop ID, items of attribute information of the corresponding shop (such as name, residence address, contact, and goods or services handled) are stored while associated with each other.

As described in FIG. 3B, the user information table and the icon information table are mutually associated (linked) by the icon ID being a key, while the user information table and the preference information table are mutually associated (linked) by the user ID being a key. Consequently, all items of information contained in those three tables are stored while associated with each other.

Next, an operation of the controller 11 having the above features is described in detail.

The icon generation unit 11a, the MyPage generation unit 11b, the MyPage edition unit 11c, the favorite setting unit 11d, the recommendation setting unit 11e, the publication setting unit 11f, the search unit 11g, the affiliation unit 11h, the recommendation generation unit 11i, the preference determination unit 11j, the screen data generation unit 11k, the main control unit 11l, and the browsing history retrieval unit 11m operate as follows.

First, the browsing history retrieval unit 11m monitors a browsing history of web pages included in any website WS through a browser on each user terminal 2, thereby constantly retrieving the browsing history to generate browsing history information for each registered user P corresponding to the user terminal 2. Since the browsing history of each user terminal 2 is automatically recorded in the browser, such information can be easily retrieved from the browsing history of the browser. Alternatively, instead of referring to the browsing history of the browser, it is also possible to directly retrieve the browsing history by monitoring a browsing activity of the browser itself. The browsing history information of the individual user P thus generated is stored in the user information DB 13 in the form of the user information table of FIG. 3A(a). The browsing history information thus stored is used in the icon generation unit 11a.

The icon generation unit 11a constantly refers to the browsing history information (which is generated by the browsing history retrieval unit 11m) of web pages browsed by a specific registered user P stored in the user information database DB 13, and retrieves HTML source codes of the referenced web pages. At this time, the icon generation unit 11a determines whether or not a referenced web page is a sales page for goods or services that belongs to a company registered to the portal site PS (registered company), and retrieves the HTML source code only where the web page is a sales page for goods or services of such a company. Whether the web page is a sales page of a registered company or not can be easily determined by, for example, recognizing whether the HTML source code of the target web page contains the registered company's domain name and a code relating to sales of the goods or services (for example, a code that processes the user's decision as to purchase, reservation, or the like of the goods or services, such as “Add to Cart,” or “Reserve,” hereinafter also referred to as user decision processing code). Then, the icon generation unit 11a extracts image information of the goods or services displayed on the sales page (that is, the file name of the goods/services identification image) and text information, such as the maker or provider name of the goods or services, the goods' or services' name, and the price. In case the sales page contains multiple items of image information, default image information is extracted. Thereafter, based on the extracted image information and text information relating to the goods or services, the icon generation unit 11a generates an icon that indicates at least a goods/services identification image (such as a sample photo of the goods or services) as well as the maker or provider name, the goods' or services' name, and the price. Accordingly, once the icon thus generated is displayed on the user terminal 2, the goods/services identification image (such as a sample photo of the goods or services) is displayed along with the maker or provider name, the goods' or services' name, and the price. A display configuration of such an icon, that is, the size of the goods/service identification image appearing on the icon, and the extent of the relevant text information included in the icon, is adjusted according to the display size of the user terminal 2, the arrangement of icons, and the like. Specifically, where it is possible to display an icon in a relatively large size, all the relevant text information is displayed in addition to the goods/services identification image in a standard size. As the available size becomes smaller, the goods/services identification image is reduced in size from the standard size, while the relevant text information with higher importance is selectively displayed (so that, for example, only the price and the maker or provider name are displayed). Hence, the information (icon information) that constitutes the icon generated for each user P in connection with a particular item of the goods/services is stored in the icon information DB 14 in the form of the icon information table of FIG. 3A(b). The above-described text information that is extracted during generation of an icon may include any text information other than the maker/provider name of the goods/services, the goods'/services' name, and the price of the goods/services, as necessary.

Based on instructions sent from the user terminal 2 via the network 4, the MyPage generation unit 11b generates a MyPage for each registered user P to which the group of icons (browsing history of each registered user P) generated by the icon generation unit 11a are posted. The MyPage displays the icons of the specific user P in a predetermined list format. The list of icons of the user P is displayed in a “Recent History” region of the MyPage of the same user P (see, for example, FIG. 8).

Based on instructions sent from the user terminal 2 via the network 4, the MyPage edition unit 11c edits the MyPage for a registered user P. The MyPage edition unit 11c also deletes and updates the icons displayed on the MyPage according to a predetermined rule.

Based on instructions sent from the user terminal 2 via the network 4, the favorite setting unit 11d sets presence or absence of “Favorite” assigned to the user's icons posted on the MyPage. Where any icons on the MyPage are set as “Favorite,” such icon group is displayed in a “Favorite” region of the MyPage (see, for example, FIG. 8). Where such presence or absence setting is changed, that is, where the “Favorite” setting for the particular icon group is updated from “Yes” to “No” or vice versa, a corresponding value of the icon group is changed, so that the contents of the “Favorite” column in the icon information table (see FIGS. 3A and 3B) of the icon information DB 14 are updated accordingly.

Based on instructions sent from the user terminal 2 via the network 4, the recommendation setting unit 11e sets presence or absence of “Recommendation” to other registered users P as to the user's icons posted on the MyPage. Where any icons on the MyPage are set as “Recommendation,” such icon group serves as icons to “recommend” the corresponding goods or services to other registered users P. Where such presence or absence setting is changed, that is, where the “Recommendation” setting for the particular icon group is updated from “Yes” to “No” or vice versa, a corresponding value of the icon group is changed, so that the contents of the “Recommendation” column in the icon information table of the icon information DB 14 are updated accordingly.

Based on instructions sent from the user terminal 2 via the network 4, the publication setting unit 11f sets presence or absence of publication to other registered users P as to the icons posted on the “Recommendation” column of the MyPage. The icon group registered to the “Recommendation” column, once set for publication, is published to other registered users P. Where such presence or absence setting is changed, that is, where publication is updated from “Yes” to “No” or vice versa, a corresponding value of the icon group is changed, so that the contents of the “Recommendation” column in the icon information table of the icon information DB 14 are updated accordingly.

In response to a search instruction from the user terminal 2 via the network 4, the search unit 11g refers to the icon information DB 14 to extract icons that match a search keyword and output such icons as a search result. The output icons are transmitted to, and then displayed on, the user terminal 2 which has sent the search instruction. As mentioned earlier, the icon information DB 14 associates each icon (goods/services identification image) with the category and keywords of the corresponding goods or services in the form of the icon information table, so that the icon group that matches the search keyword can be extracted using the category and keywords stored. Thus, the functionality of the search unit 11g enables the registered user P to search via icons generated by the icon generation unit 11a to find registered information (specifically, information relating to the goods or services recommended by other users P) associated with the icon groups stored in the icon information DB 14.

Where a user P purchases goods/services at a particular website WS and such a purchase is mediated by an icon published by another user P, that is, a “conversion” takes place wherein the user P who was merely visiting the website has converted to a customer (or a prospective customer), the affiliation unit 11h operates to offer a predetermined benefit (affiliate reward) to the publishing user P corresponding to (associated with) the mediating icon.

The recommendation generation unit 11j refers to and analyzes icon groups registered to MyPages of a plurality of users P at a predetermined timing, so as to generate pages on the top page of the portal site PS, such as an “Everyone's Recommendations” page and a “User Introduction” page for introducing a user P who has a similar preference to that of a particular user P.

The preference determination unit 11j analyzes the category, keywords and the like of the goods and services at a predetermined timing which constitute the extracted text information relating to the icons appearing on the MyPage of a particular user P, so as to determine preference of the user P. Preference information thus generated for each user P is stored in the preference information DB 18 in the form of the preference information table of FIG. 3A(c). The preference information represents only an example of the “user characteristics information,” and the present invention is not limited to such an example. Information other than preference information, such as, for example, the user's behavioral characteristic information (taste in behavior), may be used in lieu of the preference information.

In response to an instruction from the main control unit 11l, the screen data generation unit 11k generates HTML data and the like for transmission to a particular user terminal 2, and transmits the generated data to the user terminal 2 via the network 4.

The main control unit 11l performs overall control of the controller 11. That is, in response to an instruction sent from the user terminal 2 via the network 4, or alternatively in response to an instruction from the program 16, the main control unit 111 directs the operations of the icon generation unit 11a, the MyPage generation unit 11b, the MyPage edition unit 11c, the favorite setting unit 11d, the recommendation setting unit 11e, the publication setting unit 11f, the search unit 11g, the affiliation unit 11h, the recommendation generation unit 11i, the preference determination unit 11j, and the screen data generation unit 11k.

For example, in response to a request sent from the user terminal 2 via the network 4, the main control unit 11l performs a procedure for registering a new user, or more specifically, registers predetermined attribute information, such as name, residence address, and email address, of the new user and assigns a specific user ID to the new user being registered, followed by storing the relevant information in the user information DB 13 in the form of the user information table of FIG. 3A(a). Further, the main control unit 11l assigns a specific icon ID to an icon generated by the icon generation unit 11a based on browsing history information of a particular user P, associates the icon ID with information, such as the category, keywords, and the URL, of the goods or services corresponding to the icon ID, and stores the relevant information in the icon information table (icon information DB 14). Furthermore, the icon ID thus assigned is associated with the user ID of the corresponding user P by the main control unit 11l, so that the icon information table, and the user information table, and the preference information table are associated with each other. Accordingly, the main control unit 11l directs and executes the operations, besides those performed by any of the above-described icon generation unit 11a through the screen data generation unit 11k and the browsing history retrieval unit 11m, as well as coordinating operations among those units.

As described above, the server 1 having the aforementioned structures and functions allows each registered user P of the portal site PS to have the user's own MyPage as one of the functionalities of the goods/services purchase assistance system 1A, thereby providing the registered user P with the aforementioned browsing history management service and affiliation service, while serving the company C operating the website WS by assisting search and/or purchase of goods/services by the registered user P. However, the functionalities of the server 1 are not limited to the examples described above. The server 1 further includes a portal site control unit, not shown in FIG. 2, and establishes the aforementioned portal site PS on the network 4 through the portal site control unit. A description of the structures and functions of the portal site control unit is omitted because these are well known in the art. Needless to say, a web server separate from the server 1 may be provided on the network 4 to establish the aforementioned portal site PS on the network 4.

Next, the user terminal 2 is described.

FIG. 4 describes a detailed configuration of the user terminal 2 for use with the goods/service purchase assistance system 1A according to the first embodiment of the present invention.

As described in FIG. 4, the user terminal 2 includes a controller 21 that governs the overall control of the terminal, as well as a communication transmitter/receiver 22, an operation unit 23, a display 24, and a memory 25.

The controller 21 is connected to the communication transmitter/receiver 22, the operation unit 23, the display 24, and the memory 25, and can mutually send and receive signals and information therewith as required. The controller 21 comprises hardware such as a CPU and software such as a program 26 which controls the hardware. The communication transmitter/receiver 22 is a communication interface and communicates with the goods/service purchase assistance system 1A (server 1) and the web sites WS via the network 4. The operation unit 23 is an operation device, such as a mouse or a keyboard. The display 24 is a display device, such as a liquid crystal display. The operation unit 23 and the display 24 may be integrated into a touch panel. The memory 25 comprises a computer memory, a HHD, and the like, and stores the program 26 for execution by the controller 21, while providing a work area where the program 26 is executed.

The controller 21 functions as a main control unit 21a, a browser unit 21b, an instruction unit 21c, and a display control unit 21d by reading and executing the program 26 stored in the memory 25.

According to an operation of the operation unit 23, the browser unit 21b browses web pages of the websites WS provided by the web servers 3 of the companies C, and also browses the MyPage of the registered user P of the portal site PS provided by the goods/services purchase assistance system 1A (server 1). As the browser unit 21b stores browsing history of the web pages, such browsing history can be used in the browsing history retrieval unit 11m of the goods/services purchase assistance system 1A.

According to an operation of the operation unit 23, the instruction unit 21c instructs the portal site PS, that is, the goods/services purchase assistance system 1A via the network 4 to perform edition of the MyPage, favorite setting, preference setting, publication setting and the like on the user terminal 2.

According to an operation of the operation unit 23, or alternatively, according to an instruction from the program 26, the display control unit 21d controls display of characters, images, and the like on the display 24.

The main control unit 21a performs overall control of the controller 21. That is, in response to an operation of the operation unit 23, or alternatively in response to an instruction from the program 26, the main control unit 21a directs and executes the operations, besides those performed by the browser unit 21b, the instruction unit 21c, and the display control unit 21d, as well as coordinating operations among those units.

Next, with reference to a flowchart of FIG. 5A, a procedure for generating icons by the goods/services purchase assistance system 1A (server 1) is described. FIG. 5A is a flowchart describing the procedure for icon generation in the goods/services purchase assistance system 1A.

First, upon an instruction from the main control unit 111 to start an icon generation procedure for a registered user P, the icon generation unit 11a searches the user information DB 13 to refer to the browsing history information of the target user P (step S1), and accesses a URL included in the browsing history information to retrieve the HTML source code of a goods/services sales page (step S2). At this time, the icon generation unit 11a determines whether or not the browsed web page (browsed page) is a sales page of the goods/services sold by the company registered to the portal site PS based on the browsing history information. If the browsed page is a sales page of the registered company, the icon generation unit 11a retrieves the HTML source code. If the browsed page is not a sales page, the HTML source code is not retrieved. Such determination is performed, for example, based on whether or not the relevant web page contains the domain name of the registered company and a user decision processing code, such as “Add to Cart” or “Reserve.” Such determination can be easily automated by creating a URL analysis program.

Subsequently, the icon generation unit 11a extracts image information of the goods/services displayed on the sales page (the file name of the goods/services identification image) from the retrieved HTML source code of the sales page (step S3). Further, the icon generation unit 11a extracts text information corresponding to the maker/provider name of the goods/services (step S4), extracts text information corresponding to the name of the goods/services (step S5), extracts text information corresponding to the price of the goods/services (step S6), and extracts other predetermined text information, such as color, size (free, S, M, L, LL, etc.), shape (long sleeve/short sleeve, etc.), type (spring-summer clothes/winter clothes, etc.), men's or ladies' category, and target (babies, children, teens, youth, adults, seniors, etc.), of the goods/services (step S7).

Subsequently, the icon generation unit 11a generates an icon using the extracted image information and text information, and assigns a specific icon ID to the icon (step S8). Here, the maker/provider name of the goods/services, the name of the goods/services, and the price of the goods/services are selected as the text information to be combined with the image information (the file name of the goods/services identification image) corresponding to the goods/services identification image for display as the icon. Such arrangement serves to minimize the amount of text information to accompany the goods/services identification image such as a sample photograph included in the icon, which in turn maximizes simplicity of the icon and maintains readability of the text information displayed in the icon even where the goods/services identification image is reduced in size for the icon. Of course, the text information for use in the icon generation is not limited to those indicated in the description of steps S4 to S7, and any combination of the aforementioned extracted text information may be used instead.

Subsequently, the main control unit 11l identifies the category and keywords of the goods/services based on the extracted text information, then associates the identified category and keywords with the extracted URL and image information (the file name of the goods/services identification image) and with the assigned icon ID, and stores the associated information in the icon information DB 14 (step S9). The icon of the goods/services displayed on the retrieved sales page is thus generated. Thereafter, the generated icon is resized accordingly, followed by posting (adding) the icon to the MyPage of the target user P (step S10). The series of processes relating to the icon generation is completed as described above.

Alternatively, the procedure for generating icons by the goods/services purchase assistance system 1A (server 1) may be arranged as depicted in FIG. 5B. FIG. 5B is a flowchart describing another procedure for icon generation in the goods/services purchase assistance system 1A.

Specifically, first, upon an instruction from the main control unit 11l to start an icon generation procedure for a registered user P, the icon generation unit 11a refers to the browsing history information of the target user P (step S1a), and retrieves the HTML source code of a goods/services sales page (step S2a) in a manner similar to that depicted in steps S1 and S2 of FIG. 5A. Then, the icon generation unit 11 a confirms whether or not the web page belongs to the registered company based on the HTML source code (step S3a). If the web page is confirmed to belong to the registered company, the procedure proceeds to a subsequent step S4a, at which the icon generation unit 11a confirms whether or not the web page is a sales page of the goods/services. The procedure ends without performing subsequent steps if the web page is confirmed (determined) not to belong to the registered company at step S3a, or if the web page is confirmed (determined) not to be a sales page of the goods/services at step S4a. The determination at step S3a is performed, for example, based on whether or not the relevant web page contains a domain name, logo, code, or the like of the registered company. The determination at step S4a is performed, for example, based on whether or not the relevant web page contains a user decision processing code, such as “Add to Cart” or “Reserve.” Such determinations can be easily automated by creating a URL analysis program.

Following step S4a, the icon generation unit 11a extracts image information of the goods/services displayed on the sales page (the file name of the goods/services identification image) and predetermined text information such as the maker/provider name of the goods/services from the retrieved HTML source code (step S5a). The text information extracted here is similar to that in the example of FIG. 5A. Then, the icon generation unit 11a resizes the extracted goods/services image information according to a display area (step S6a), followed by generating an icon using the extracted image information and text information, and assigning a specific icon ID to the icon (step S7a).

Subsequently, the main control unit 11l identifies the category and keywords of the goods/services based on the extracted text information, then associates the identified category and keywords with the extracted URL and image information (the file name of the goods/services identification image) and with the assigned icon ID, and stores the associated information in the icon information DB 14 (step S8a) in a manner similar to that depicted in step S9 of FIG. 5A. The icon of the goods/services displayed on the retrieved sales page is thus generated. Thereafter, the generated icon is associated with preference information (which is stored in the preference information DB 18) of the user P corresponding to the icon (step S9a), followed by posting (adding) the icon to the MyPage of the target user P (step S10a). The series of processes relating to the icon generation is completed as described above.

The aforementioned preference information may be derived, for example, in a manner depicted in FIG. 16. Specifically, first, icon information that relates to the icon registered as favorite is referenced (step S11). More specifically, the icon information to be referenced here includes extracted text information, such as the maker/provider name of the goods/services, the name of the goods/services, and the price, stored in the “EXTRACTED TEXT” column of the icon information DB 14. Then, common information words (such as, for example, LADIES, COMPANY-A, MINI, etc., which appear in the WORD column depicted in FIG. 20) are extracted from the extracted text information, and preference priorities are determined according to decreasing counts of the words, that is, descending order of frequency by which such words appear (step S12). Thereafter, the relevant user preference is determined based on the extracted information words and the determined priorities (step S13). The preference information thus obtained is registered (stored) for each user P in the preference information DB 18 (step S14). The preference information of each user P is obtained as described above. Needless to say, the preference information may be derived in a manner different than that depicted herein.

To facilitate better understanding, a specific example of the aforementioned icon generation procedure is described below.

Websites of a given company are registered to the portal site PS in advance (hereinafter, referred to as registered company websites), and a dedicated analysis program is provided in the icon generation unit 11a. For example, suppose that a website has the URL: http://infinity-soft.co.jp/infinity-shop.htlm. In that case, whether or not the relevant website is the registered company website can be easily determined by, for example, extracting a character string “infinity-soft.co.jp” from the URL to compare with URLs pre-registered to the goods/services purchase assistance system 1A. Needless to say, it is possible to refer to the browsing history of registered users P to cumulatively register additional, unregistered company websites.

If the website is determined to be a registered company website at this point, then, it is determined whether or not the web page browsed by the user at the website is a sales page. Since sales pages on a single website usually have the HTLM source of a common format, necessary information may be easily extracted from the HTLM source by providing an analysis program that suits the individual company's HTLM source format. This is a popular technique commonly known as scraping. For example, suppose that the HTLM source of the sales page of the above website describes an “Add to Cart” button as <id=“btn_addcart”>. In that case, a web page may be identified as a sales page if the character string <id=“btn addcart”> can be extracted from the HTLM code (description) of the web page by the website-specific analysis program.

Where the above web page is determined to be the registered company's sales page, then, information required for icon generation/preference determination or the like is extracted from the HTLM source of the relevant web page by the aforementioned analysis program. For image information, an image file (for example, abcxyz.jpg) identified by the aforementioned analysis program is extracted. The extracted image information is used for icon generation and displayed in the icon. Typically, the sales page is associated with multiple images (such as, for example, a front view, right and left side views, a partial enlarged view, and a view showing the used state of a particular item of goods), so that any (either single or multiple images) of those images can be displayed in turn on the sales page. In the present case, a “default image” that represents the relevant sales page is designated, so that the “default image” is always displayed unless specified otherwise. Hence, the “default image” is extracted for use in the icon. Likewise, items of text information such as the title name and price of the goods/services are individually extracted by the aforementioned analysis program, so that the extracted information is used for icon generation and displayed in the icon. Where other information, for example, text information identifying the target category such as ladies'/men's is extractable, such information is used as target information of the icon. Where text information identifying the goods category such as jacket/skirt/etc. is extractable, such information is used as category information of the icon. Moreover, for example, where text information of keywords is extractable from the HTLM source of the web page, keyword information that matches keywords pre-registered as words for extraction in the goods/services purchase assistance system 1A is extracted to be used as sub information for the icon. It should be noted that not all the extracted text information need be displayed on the icon, and information other than minimum necessary text information such as the name of the goods and the price is set aside as the icon's storage information which does not appear on the icon. Also, any of the text information may be used to determine the user characteristics such as preference of the relevant user.

Next, with reference to FIG. 6, the aforementioned icon generation procedure is described using an example of a website WS (web shop) that sells various goods, such as clothes, shoes, and bags. FIG. 6 is a conceptual diagram describing the icon generation procedure in the goods/services purchase assistance system 1A. Although the following description pertains to the sales of “goods,” needless to say, the icon generation procedure described herein is similarly applicable to the sales of “services” as well.

Among the web shops provided in individual websites WS, the website WS (web shop) selling the collection of goods such as clothes, shoes, and bags may have sales pages such as those depicted in FIG. 6, for example. Numerous sales pages 100 as depicted in FIG. 6 may exist corresponding to the number of goods being handled. Since a predetermined rule generally exists which equally applies to the HTML source code of the collection of sales pages 100, however, performing analysis to comprehend that rule allows for extracting the image information (the file name of an image) of each item of goods, as well as the text information, such as the maker (provider) name of the goods, the name of the goods, and the price, from the collection of sales pages 100 with a single identical algorithm. For example, identifying whether or not the HTML source code includes a user decision processing code, such as “Add to Cart,” “Purchase,” or “Reserve,” allows for determining whether the corresponding web page is a sales page or not. The image information and text information thus extracted for the goods is resized (typically reduced in size) for use with the icon. An icon 101 thus generated assumes a format in which the maker (provider) name of the goods, the goods (service) name, the price, and the like, are listed near the image identifying the goods, so that the viewer can readily understand the nature of the goods presented. As mentioned earlier, the icon is assigned a specific icon ID. The retrieved URL and the extracted text information (maker/provider name, goods name, price, size, color, etc.), as well as the category, keywords, and the like are associated with the icon ID as they are together stored in the icon information DB 14 and thereby managed. Such icon generation is performed by the icon generation unit 11a of the goods/services purchase assistance system 1A, as described above.

FIG. 7 is a conceptual diagram that describes a process through which an icon is registered to a MyPage of the user P in the goods/services purchase assistance system 1A.

As depicted in FIG. 7, the procedure for generating icons based on the web pages of different websites WS is similar to that depicted in FIG. 6. Specifically, in FIG. 7, the aforementioned predetermined rule for each of a sales page 111 of the website WS of Company-A, a sales page 112 of the website WS of Company-B, and a sales page 113 of the website WS of Company-C can be comprehended by retrieving and analyzing the HTML source code. Accordingly, following that rule to extract the image information of the goods (item) and the text information, such as the maker (provider) name, the goods name, and the price, allows for generating icons 114, 115, and 116 corresponding to the sales pages 111, 112, and 113, respectively, of the different companies C in a manner similar to that depicted in FIG. 6. The icons 114, 115, and 116 thus generated are added (posted) to a MyPage 117 of the target registered user P.

As depicted in FIG. 7, posting the icons 114, 115, and 116 relating to the goods (items) of Company-A, Company-B, and Company-C, respectively, may be restricted in terms of date, number, or the like, so that icons are deleted in chronological order starting with the oldest, or older icons are replaced with newer ones. Such arrangement is desirable because it prevents excessive memory resources dedicated to the icons. Where the user P clicks any of the item icons 114, 115, and 116, the corresponding URL is read from the icon information DB 14, followed by a redirect to the web page corresponding to the URL (or displaying such a web page in a separate window).

At the bottom of FIG. 7 is a “Recent History” screen shown in the MyPage 117 of the user P, in which four types of buttons are displayed in association with each of the icons 114, 115, and 116. Since each button serves an identical function for all the icons 114, 115, and 116, only the buttons associated with the icon 114 are described herein. Specifically, a button 114a represents a button relating to favorite setting, a button 114b represents a button relating to presence or absence of recommendation setting, a button 114c represents a button for searching for similar items from other user's recommendations, and a button 114d represents a button relating to icon deletion. Clicking any of the buttons 114a, 114b, 114c, and 114d allows for performing a predetermined setting assigned to the clicked button. Also, in response to the setting being performed, a change is made to the display mode of the icons 114, 115, and 116 in the “Recent History” screen (for example, a change in color).

In the MyPage 117 shown at the bottom of FIG. 7, selecting a “Favorite Items” tab causes a transition to a “Favorite Items” screen 120 as depicted in FIG. 8. The “Favorite Items” screen 120 displays only a limited list of icons 121, 122, 123, etc., that have been registered as favorites in the “Recent History” screen (FIG. 7). The “Favorite Items” screen 120 includes a button 120a for brand (shop name) search, a button 120b for category search, and a free word search box 120c. Also, a button 120d for changing the layout of the MyPage 117 is provided. Selecting the button 120d causes a transition to a screen 124 shown beneath the screen 120. The screen 124 displays separate regions 125, 126, and 127, representing detailed views corresponding to the icons 121, 122, 123, etc., respectively, listed in the previous screen 120. Thus, clicking the button 120d causes a transition to the detailed view screen 120, so that extracted text information relating to the respective icons 121, 122, and 123 is displayed in greater amounts (details), which enables the user P to understand more thoroughly the goods (items) being displayed.

In the “Favorite Items” screen 120 of the MyPage 117 shown in FIG. 8, selecting an edition button 121a of the icon 121 causes a transition to an “Edit Favorite Item” screen 130, as depicted in FIG. 9. In the “Edit Favorite Item” screen 130, the brand (shop name) can be altered by selecting a change button 130a, and the category can be altered by selecting a change button 130b. Further, a detailed view region 131 is provided in an upper part of the “Edit Favorite Item” screen 130, and a comment box 132 is provided beneath the detailed view region 131 allowing input of comments regarding the goods (item). Examples of comments for entry into the comment box 132 may include recommendation comments, such as “THIS IS A VERY LIGHTWEIGHT COAT DESPITE ITS GREAT WARMTH. SIZE S IS A RIGHT FIT FOR HEIGHT 158 CM,” and conversely, critical comments as well. Comments entered in the comment box represent word of mouth by the users of a particular item (goods) that constitutes the favorite item, and since they are quite influential in motivating other users P to purchase the goods, providing the comment box 132 here is meaningful. Additionally, an image posting box 133 and a video posting box 134 are disposed beneath the comment box 132, allowing posting of a still image or a video relating to the goods (item) displayed on the detailed view region 131. Such arrangement enables another user P who has responded to the recommendation comments entered in the comment box 132 to view additional information relating to the goods (item) displayed on the detailed view region 131.

To return to the screen 120 of FIG. 8 without making any particular edition after reviewing the “Edit Favorite Item” screen 130 of FIG. 9, a return-without-edit button 135 may be clicked. Conversely, where an edition is made, a review button 136 may be clicked to review edited contents. Clicking the review button 136 causes a transition to a “Review Edition Result” screen 137 shown beneath the review button, in which the result of edition can be reviewed consequently. After the edited contents are reviewed in the “Review Edition Result” screen 137, a confirm-change button 139 may be clicked to confirm the edited contents. Conversely, a return-to-edition button 138 may be clicked to return to the edition screen 130. The edition of the MyPage 117 described above is performed by the MyPage edition unit 11c of the goods/services purchase assistance system 1A based on instructions from the instruction unit 21c of the user terminal 2.

Selecting the similar item search button 114c shown in the MyPage 117 of FIG. 7 causes a transition to a predetermined “Search” screen. An example of the “Search” screen is depicted in FIG. 10. As shown in FIG. 10, a “Search” screen 140 includes a button 142 for exploring similar items from “Everyone's Recommendations” and a button 143 for exploring items of users having similar tastes, both of which are disposed below a detailed information display region 141 for an item (goods) relating to the selected icon. Selecting the button 142 for exploring similar items from “Everyone's Recommendations” displays items (goods) that are similar to the item displayed on the detailed information display region 141 and are recommended by other users P, so that the user can search for a desired item (goods) while consulting the list of items (goods) as reference information. Selecting the button 143 for exploring items of users having similar tastes displays items (goods) that are similar to the item displayed on the detailed information display region 141 and are recommended by other users P whose tastes are similar to the user's own taste, so that the user can search for a desired item (goods) while consulting the list of items (goods) as reference information.

In the “Search” display 140, selecting the button 142 for exploring similar items from “Everyone's Recommendations” causes a transition to a recommended item list screen 144 shown beneath the “Search” screen 140 of FIG. 10. The screen 144 includes a list of items (goods) in the form of icons 145, which are similar to the item displayed on the detailed information display region 141 and are recommended by other users P. Selecting any of the icons 145 from the list causes a transition to a recommendation item detail screen 146 describing a “Recommendation” by the user relating to the selected icon. Such a screen 146 is depicted beneath the recommended item list screen 144. The screen 146 includes an item (goods) detailed information display region 147, which displays the comments entered in the comment box 132 of the “Review Edition Result” screen 137 of FIG. 9, a still image posted on the image posting box 133, a video posted on the video posting box 134, and the like. Accordingly, more detailed information relating to the items (goods) that are similar to the item displayed on the detailed information display region 141 and are recommended by other users P can be obtained from the detailed information display region 147. Below the detailed information display region 147 is a region 148 in which icons of other items (goods) recommended by the particular user P relating to the selected icon are listed. Selecting an “Open Item Page” button 149 provided in the detailed information display region 147 causes a transition to the sales page for the relevant item of goods. Further, selecting a “View All Recommendations” button 150 provided in the icon listing region 148 causes a transition to a screen listing the icons relating to all the “Recommendation” items (goods), including the images of items listed in the icon listing region 148. Additionally, selecting a “Register as Favorite User” button 146a of the screen 146 describing the “Recommendation” allows for registering (setting) the user P corresponding to the selected icon as a favorite user. Further, where the user P owing the MyPage 117 of FIG. 7 is redirected to a sales page via the selected icon and a conversion results, that is, the browsing user P converts from a visitor to a customer (or a prospective customer), it is possible to pay a reward to a user P corresponding to the selected icon through the affiliation unit 11h of the goods/services purchase assistance system 1A.

Conversely, selecting the “Explore Items from Users Having Similar Tastes” button 143 in the “Search” display 140 of FIG. 10 causes a transition to a screen 151, as depicted in FIG. 11. The screen 151 includes a selection of other users P whose tastes are similar to that of the user P owning the MyPage 117 of FIG. 7, displaying icons relating to items (goods) set as favorites by those selected users P. Then, selecting any of “See All Recommendations of ΔΔΔ” buttons 152 displayed for the respective selected users P in the screen 151 causes a transition to a screen 153, which includes a list of icons 154 set as favorites by the selected one of the users P whose tastes are similar to that of the user P owning the MyPage 117. The screen 153 is depicted beneath the screen 151. Selecting any of the icons 154 displayed in the screen 153 causes a transition to the screen 146 describing a “Recommendation” by the selected user, as described earlier with reference to FIG. 10. Accordingly, initially viewing the screen 151 enables the user P owning the MyPage 117 shown in FIG. 7 to review a summary of the items (goods) recommended by a plurality of users P who have similar tastes as the reviewing user P. Thereafter, the reviewing user P can further specify a particular one of the users P who have similar tastes as the reviewing user P, so as to review the details of the items (goods) recommended by the specified user P via the icons. The search mediated by the icons described above is performed by the search unit 11g of the goods/services purchase assistance system 1A based on instructions from the instruction unit 21c of the user terminal 2 via the network 4. Additionally, selecting a “Register as Favorite User” button 153a of the screen 153 allows for registering (setting) the selected user P as a favorite user. Further, where a redirect to the sales page occurs via any of the displayed icons, resulting in a conversion, it is possible to pay a reward to the user P corresponding to the relevant icon through the affiliation unit 11h of the system 1A.

In the MyPage 117 shown at the bottom of FIG. 7, selecting a “Favorite Users” tab causes a transition to a screen 160, as depicted in FIG. 12. The screen 160 displays a list of icons relating to the items (goods) recommended (set as favorites) by users P registered as favorites by the user P owning the MyPage 117 of FIG. 7. Then, selecting any of “See All Recommendations of ΔΔΔ” buttons 161 displayed for the respective favorite-registered users P in the screen 160 causes a transition to a recommendation item screen 162, which includes a list of icons 163 relating to items (goods) set as recommendations by the selected user P. The recommendation item screen 162 is depicted beneath the screen 160. Accordingly, initially viewing the screen 160 enables the user P owning the MyPage 117 of FIG. 7 to review a summary of the items (goods) recommended by a plurality of users P set as favorites by the reviewing user P. Thereafter, the reviewing user P can further specify a particular one of the users P who seems interesting, so as to review the details of the items (goods) recommended by the specified user P via the icons. Additionally, the order in which the users P registered as favorites appear can be selected from any appropriate orders, such as the order in which the favorite-registration is updated, the order in which the favorite-registration is made, and the alphabetical order of names (nicknames). Selecting one of the icons 163 displayed on the screen 162 causes a transition to the screen 146 (see FIG. 10) describing a “Recommendation” of the user P relating to the icon 163. Further, where the user P owning the MyPage 117 of FIG. 7 is redirected to a sales page via the icon 163, resulting in a conversion, it is possible to pay a reward to the user P corresponding to the relevant icon 163 through the affiliation unit 11h of the goods/services purchase assistance system 1A.

Referring now to FIG. 13, the screen transition from the home page of the portal site PS is described.

As described in FIG. 13, a home page screen 170 of the portal site PS provided by the portal site operation company PC through the server 1 includes three buttons 170a, 170b, and 170c arranged horizontally in series in an upper part of the screen 170. Selecting the partner shop (sponsor) button 170a redirects a user P to a web page of the partner shop. Selecting the “Everyone's Recommendations” button 170b causes a transition to the “Everyone's Recommendations” web page. Selecting the MyPage button 170c causes a transition to the “MyPage” page of the user P. A button 170d for brand search and a button 170e for category search are disposed in a left-side part of the home page screen 170. Regions for displaying banner ads 171, 172, and 173 are disposed in a middle part of the home page screen 170. Also, “Everyone's Recommendations” icons 174 are shown for illustration in a lower part of the home page screen 170. Selecting the banner ad 172 of the partner shop causes a transition to a web page 176 of the relevant partner shop. Also, selecting one of the icons 174 displayed in the “Everyone's Recommendations” causes a transition to a detailed description screen 175 of the relevant icon. Where a user P is redirected to the sales page via any of the icons 174 and a conversion results, it is possible to pay a reward to the user P corresponding to the relevant icon through the affiliation unit 11h of the goods/services purchase assistance system 1A.

Next, with reference to FIG. 14, individualization of information in search results displayed where a search is performed on the home page of the portal site PS of FIG. 13, that is, procedure for prioritizing display of icons according to preference of the searching user is described.

In the goods/services purchase assistance system 1A, the preference determination unit 11j performs real-time analysis/determination of preference of each individual user P based on the information relating to the icons set as “Favorites” in the user's P own MyPage, thereby generating the preference information of each individual user P, which is saved in the form of a preference information table for each user P in the user information DB 13. Then, in case a search is performed on the home page of the portal site PS, the preference information saved in the user information DB 13 is used to select information (specifically, icons) that matches the preference of the searching user P for display as search results. The following describes such procedure using a specific example.

As described in FIG. 14, suppose a user A, who is a registered user of the portal site PS, has a strong preference for a brand A (strongly favors the brand A) and a moderate preference for color yellow. Suppose also a user B, who is another registered user of the portal site PS, has a strong preference for color black and a moderate preference for certain brands (favors several brands collectively). In that case, where each of the users A and B enters an identical search keyword “SKIRT” in the search box at the home page of the portal site PS to perform a keyword search, the search results for the user A preferentially display icons of skirts in the color that matches the preference of the user A (yellow), mainly those of the brand A for which the user A exhibits a strong preference, that is, those icons are listed primarily in the search results. For the user B, the search results preferentially display icons of skirts mainly in the color black for which the user B exhibits a strong preference, arranged by brands in order of preference of the user B, that is, those icons are listed primarily in the search results. Thus, based on the results of preference determination by the preference determination unit 11j, the search unit 11g of the goods/services purchase assistance system 1A displays search results which match the individual preferences of the respective users A and B. Accordingly, each of the users A and B can obtain useful information for individual goods selection by referring to the icons displayed in the search results, leading to further facilitated and expedited goods selections. Also, such arrangement incentivizes the users A and B to use more of the portal site PS.

Next, with reference to FIG. 15, characteristics of the icon generated by the goods/services purchase assistance system 1A are described in further details.

Icons generated by the icon generation unit 11a of the goods/services purchase assistance system 1A are created for individual goods/services based on the browsing history information of individual registered users P, and each icon is associated with a particular registered user P and particular goods/services. That is, even where icons are generated including an identical goods/services image (goods/services identification image) based on browsing history information of two different registered users P browsing the same goods/services on the same sales page of the same website WS, those icons generated as the browsing history information of both users P are each individually generated and managed in one-to-one correspondence with a corresponding, particular user P. As such, where the search unit 11g of the goods/services purchase assistance system 1A performs a search in response to an instruction by a third user P, icons for display in the search results on the user terminal 2 may include two (or three or more) identical icons containing URL information (goods/services identification image) of the identical goods/services (identical sales page). In that case, among two users P corresponding to (that is, owning) these two identical icons, the search unit 11g preferentially extracts an icon that belongs to a user P whose preference is more similar than the other to that of the third user P who is performing the search, and presents the extracted icon as a search result.

Referring to FIG. 15, the following is an explanation using a specific example. As described in FIG. 15, suppose that two registers users A and B have performed searches using their individual user terminals 2, resulting in retrieval of two icons 180a and 180b including identical goods/services URL information (identical sales page). In that case, these two icons 180a and 180b are identical to each other in terms of the image displayed therein (appearance), but are different from each other in terms of the owner, wherein the users associated with the icons 180a and 180b are users C and D, respectively. As described in FIG. 15, the search unit 11g then selects and displays the icon 180a of the user C whose preference is closer to that of the user A as a search result for the user A, while selecting and displaying the icon 180b of the user D whose preference is closer to that of the user as a search result for the user B. Consequently, by selecting the icon 180a presented as her search result, the user A moves to a recommendation item detail screen 181 of the user C. Since the screen 181 displays not only the recommendation item corresponding to the icon 180a but also some icons relating to other items recommended by the user C, such arrangement can encourage the user A to review other items recommended by the user C. Similarly, by selecting the icon 180b presented as her search result, the user B moves to a recommendation item detail screen 182 of the user D. Since the screen 181 displays not only the recommendation item corresponding to the icon 180b but also some icons relating to other items recommended by the user D, such arrangement can encourage the user B to review other items recommended by the user D.

Where the user A is converted through a sales page 183 relating to the icon 180a of the user C, the affiliation unit 11h may pay a reward to the user. Similarly, where the user B is converted through a sales page 183 relating to the icon 180b of the user D, the affiliation unit 11h may pay a reward to the user D. Accordingly, even if two or more icons are presented displaying images relating to the same goods/services in an initial stage, subsequent selection of any one of those icons causes an automatic transition to the recommendation item detail screen of a user whose preference is close to that of the searching user, so that the searching user can stay constantly informed about items browsed and recommended by other users who have similar preferences as her own, thereby obtaining reference information useful for the user to make her own item selection or purchase.

FIG. 17 is a description of the above procedure performed by the search unit 11g where icons for display in the search results include two or more icons containing URL information (goods/services identification image) of the identical goods/services (identical sales page), wherein, among two or more users corresponding to those icons, an icon belonging to a user P whose preference is more conforming (similar) than others to that of the third user P performing the search is selected for preferential display in the search results.

As depicted in the flowchart of FIG. 17, the search unit 11g initially searches the icon information DB 14 for icons that match search criteria entered by the searching user P (step S21), and extracts all icons matching the search criteria (step S22). Then, the search unit 11g determines whether or not the entirety of the extracted icons include icons which share an identical URL while owned by two or more users P (owners) (step S23). Where such icons are determined to exist, the procedure proceeds to next step S24 at which the search unit 11g retrieves preference information of all relevant users from the preference information DB 18 and compares the relevant users' preferences to each other (step S24). Then, the search unit 11g determines display priorities for all the relevant icons according to the levels of similarity to the searching user P in terms of preference (the degree by which preference of the searching user P is approximated) (step S25). Thereafter, the search unit 11g displays the relevant icons in search results in order of their determined display priorities (step S26). Icons other than those having identical URL and different users P (owners) are displayed in order of relevance to the search criteria. Conversely, where the search unit 11g determines that no icons exist which share an identical URL while owned by two or more users P (owners), the procedure directly jumps to step S26 at which the extracted icons are displayed in the search results in order of relevance to the search criteria (step S26).

Instead of displaying all icons that share an identical URL while owned by two or more users P (owners) in order of their determined display priorities in search results, alternatively, it is also possible to select a sole icon that has the highest display priority among all the relevant icons, and display only the selected icon in search results.

Typical examples of the sales page 183 described in FIG. 15 are shown in greater details in FIGS. 22A and 22B. In the sales page 183 of FIG. 22A, an image of the goods (feminine blouse) is located on the left side, along with the name of the goods, a price, three size buttons representing sizes S, M, and L, and an “Add to Cart” button vertically arranged/displayed on the right side. After size selection is completed by clicking any of the S, M, and L buttons, clicking the “Add to Cart” button by a user P (user A or user B) signifies that the clicking user P has decided to buy the goods (feminine blouse) displayed on the sales page 183 in the specified size, that is, making a decision to “purchase” (or at least “select”). This is so because to “Add to Cart” amounts to placing the relevant item of goods in a shopping cart.

The sales page 183 of FIG. 22B is identical to the sales page 183 of FIG. 22A except that individual “Add to Cart” buttons, one for each size, are provided. Specifically, in lieu of the omitted three size buttons representing S, M, and L, the “Add to Cart” buttons are provided corresponding to the respective sizes.

With the sales page 183 depicted in either of FIGS. 22A and 22B, it is possible to monitor whether or not the “Add to Cart” button is clicked, subject to partnership agreement with the company C, allowing the goods/services purchase assistance system 1A to recognize that the user P browsing the page 183 has “purchased” the goods, or that such a user P at least once “selected” the goods for purchase although no purchase is ultimately made. Additionally, while some web pages are known which have a button to “Proceed to Purchase (Order)” upon reviewing (collectively) the goods/services added to the shopping cart, and others have a button to “Complete Payment” upon selecting a payment method, such web pages do not qualify as a “sales page (goods/services sales web page).”

FIGS. 19 to 21 describe a specific example of procedure for analyzing/deriving preference of a user P based on information relating to icons registered as favorite items in the MyPage of the subject user P, and selection (matching) of other users P who have similar preferences to that of the subject user P.

Suppose that, as described in FIG. 19, the icons registered as favorite items are represented by ICON1-ICON15. Also suppose that extracted texts associated with the icons ICON1-15 (see the icon information tables of FIGS. 3A and B) are organized in a table of FIG. 19 and saved in the icon information DB 14. In that case, as shown in the table of FIG. 19, the icons ICON1-15 each includes a number of words that fall under main information, such as target, goods category, and brand (company), and sub information including particulars, such as shape, image, pattern, color, and material. Here, a table as described in FIG. 20(a) can be obtained by extracting, for example, words that constitute 20% of the main and sub information items combined to calculate a proportion (percentage) of each word.

The table of FIG. 20(a) reveals that the proportion of the word LADIES under the rubric “TARGET” is the largest, followed by the word COMPANY-A under the rubric “BRAND (COMPANY)” being the second, and the word MINI under the rubric “SHAPE” being the third. Further, the fourth is the word ONE-PIECE under the rubric “CATEGORY,” the fifth is the word SKIRT under the rubric “CATEGORY,” the sixth is the word COMPANY-C under the rubric “BRAND (COMPANY),” and the seventh is the word PINK under the rubric “COLOR.” These results are represented in a pie chart as shown in FIG. 20(b).

To select other users P having preference most conforming to (matching) that of a third user P performing a search, for example, in case of “Explore Items from Users with Similar Tastes” in the “search” screen 140 of FIG. 10, users P who are similar to the searching user P in terms of the above-described words as well as their proportions (distribution pattern) used to derive the preference may be selected, so that the search results display these selected users in descending order of priority.

FIG. 21 describes a specific example of combination of determination criteria and words used to analyze/derive preference of a user P from information relating to icons registered as favorite items in the MyPage of the subject user P. The combination shown in a table of FIG. 21 is used in the procedure of FIG. 19 and FIG. 20. Such a table may be referred to by a program for performing preference analysis/derivation, so that desired preference information can be automatically derived from a URL source code obtained from the browsing history information of a sales page.

FIG. 18 depicts an overall operation of the goods/services purchase assistance system 1A having the above structures and functions. Since specific operations are already described, an explanation of FIG. 18 is omitted.

As described above, owing to the aforementioned structures and functions provided in the goods/services purchase assistance system 1A according to the first embodiment of the present invention, where an individual registered user P of the portal site PS uses the user terminal 2 of his or her own to browse a web page for selling goods/services (sales page) of the website WS to explore goods/services of interest, icons relating to the above goods/services of interest (relevant icon group) selected among all icons published by other registered users of the portal site PS are displayed on the user terminal 2 of the browsing user P, so that the displayed icons can be used as reference information. In that case, a number of icons are displayed as search results on the user terminal 2 of the browsing user. Where those icons include two or more duplicate icons (having different icon IDs) which share an identical URL (goods/services identification image) while belonging to different users P (user IDs), an icon published by a user P whose “preference,” which is a user characteristic, is more similar than others to that of the user P requesting display of the above relevant icon group is selected from among the two or more duplicate icons for preferential display in the search results.

Accordingly, the above user P requesting display of the relevant icon group can easily learn in what goods/services from the website WS each of other users P having the similar user characteristic or “preference” as the subject user P is interested (past goods/services browsing record), and what goods/services are being recommended by those other users (recommended goods/services). Knowing such facts enables the user P requesting display of the relevant icon group to avoid spending hours going through numerous web pages within the website WS in search of the goods/services of interest, and therefore is extraordinarily useful to the subject user P.

Thus, the goods/services purchase assistance system 1A can assist a registered user P of the portal site PS to swiftly and easily search for or purchase desired goods or services while consulting appropriate past goods/services browsing records and recommended goods/services of other registered users P whose user characteristic such as preference is similar to that of the subject user P, even where goods and services of various brands, makers/providers, prices, designs, and the like are spread over a number of goods/services sales web pages in the website WS. Such capability translates into the ability to provide easy and secure assistance for search or purchase of goods or services by the user P utilizing the portal site PS.

From the standpoint of the operation company C of the website WS in which the goods/services sales web pages are provided, it is possible to promote sales of goods or services on the goods/services sales web pages included in the website WS simply by obtaining web page browsing history information of individual users P utilizing the portal site PS.

Moreover, since the web page browsing history information of individual users P utilizing the portal site PS can be accumulated in the portal site PS, each user P can integrally manage the browsing history information of different websites WS.

Further, the goods/services purchase assistance system 1A provides the following advantages as well. Specifically, the aforementioned icon information DB 14 stores and associates extracted text information (for example, maker name (brand name), goods name, price, and the like) besides those described above. Accordingly, the system 1A can generate icons based on the user's browsing history information to enable retrieval of registered information (extracted data, category, keyword, etc.) via the generated icons, so that the retrieved information can be consulted by multiple users P. Since the goods/services image, the maker (provider) name, the goods/services name, and the price are indicated in the icon, such an icon serves an additional function as an information communication means. The icons generated based on the browsed web pages may be listed in the MyPage of the user P, so that the user P can simply check out the MyPage to quickly review the goods or services in which the user P was previously interested, and to immediately move to the details screen pertinent to each item of the goods or services.

Furthermore, the system 1A includes the search unit 11g which performs search via the icons. The search unit 11g refers to the icon information DB 14 being the memory, extracts icons corresponding to a search keyword based on the category and keywords associated with the icon ID, and outputs the extracted icons as search results. Accordingly, to perform a search by category, or by free keyword, in addition to a search by brand, the icon information DB 14 can be consulted to extract categories or keywords that match a relevant keyword or the like included in the search, so as to output the extracted information as search results, and such output results can be provided in a list of relevant icons to the user P. In that case, among all the icons listed in the search results, the user P can specify a particular icon which the user desires to learn in further details. Since selecting the icon causes a transition to the details screen, the user P can easily review the details of goods or services in the details screen.

Still further, the system 1A includes the preference determination unit 11j that determines user preference. As mentioned earlier, the icon information DB 14 being the memory further stores text information including extracted text information (such as, for example, maker names, goods names, prices, colors, sizes (free, S, M, L, LL, etc.), shapes (long-sleeve/short-sleeve, etc.), types (spring-summer clothes/winter clothes, etc.), men's/ladies' category, and target (babies, children, teens, youth, adults, seniors, etc.)). The preference determination unit 11j determines preference of the user P based on the information stored in the icon information DB 14. In case an icon group includes multiple icons which are generated based on the same web page and share an identical image while belonging to different owners, the search unit 11g selects and output an icon relating to a user P who has a similar preference to that of the subject user based on the results of determination by the preference determination unit 11j. Accordingly, even where multiple icons of an identical image exist which are generated from the sales page HTML source code derived from the browsing history of the sales page of the same website WS, those icons are associated with different users P, and individual users P have different preferences. Hence, presenting icons of another user P whose preference is closer than others to that of the subject user P provides search results optimized according to preference of the subject user P, allowing quick review of other icons set as recommendations by the other user P having the similar preference.

Additionally, the goods/services purchase assistance method according to the present invention is a method performed in the goods/services purchase assistance system 1A described above. Also, the goods/services purchase assistance program according to the present invention is a program incorporated in the goods/services purchase assistance system 1A described above. Further, the computer-readable recording medium storing such a program 16 comprises the recording medium 17.

### Second Embodiment

Now, a goods/services purchase assistance system 1B according to a second embodiment of the present invention is described. The overall configuration of the goods/services purchase assistance system 1B according to the second embodiment is substantially similar to that of the goods/services purchase assistance system 1A according to the first embodiment described above, except that the configuration of the control unit is different.

FIG. 23 describes a configuration of the goods/services purchase assistance system 1B according to the second embodiment. Here, the same reference numerals represent identical parts as those of FIG. 2, and duplicative explanation will be omitted. As described in FIG. 23, the system 1B differs from the system 1A of FIG. 2 in that a control unit 11B is further capable of functioning as an icon update unit 11n by reading and executing a program 16B stored in the memory 15. Other structural and functional aspects of the system 1B are similar to those of the system 1A of FIG. 2.

At predetermined time intervals, or alternatively, when a user P has selected a particular icon for a predetermined number of times or more, the icon update unit 11n accesses a URL associated with the icon to obtain an HTML source code of the web page (sales page) relating to sales of the goods or services. Then, the icon update unit 11n extracts image information of the goods/services, as well as text information, such as the maker/provider name, goods/services name, and price, from the obtained HTML source code, and compares the extracted information to information stored in the icon information DB 14, so as to determine whether or not a change has occurred. Where there has been a change, the icon update unit 11n updates the data according to the change, and newly generates an updated icon using the image information and text information (the maker name, goods name, and price, in the present example), followed by replacing the existing icon in the MyPage or the like with the newly generated icon.

For example, the icon update unit 11n updates a price displayed in the icon where the price text information extracted for update has been changed. In addition, when failing to extract a price but obtaining text information such as “Sold out” or “Backordered” instead, the icon update unit 11n associates the icon DB 14 with expiration information and deletes the expired icon from the MyPage or the like, without creating a new icon. Such arrangement is designed to prevent a transition to the company's website WS for purchase through the expired icon. Alternatively, the icon update unit 11n may newly generate an icon labeled “Sold out” or “Backordered” instead of displaying a price to replace the expired icon in the MyPage or the like with the newly generated icon.

Where the icon update unit 11n fails to access a URL associated with an icon during the icon update procedure described above, the icon update unit 11n determines that the page relating to the goods/services no longer exists, and associates the icon DB 14 with expiration data and deletes the expired icon from the MyPage or the like.

As described above, owing to further provision of the icon update unit 11n that updates an icon at predetermined time intervals, or alternatively, where the user has selected the icon for a predetermined number of times or more, the goods/services purchase assistance system 1B according to the second embodiment of the present invention has the ability to occasionally update the image information and text information relating to stored icons, thereby facilitating update of stored information, in addition to the advantageous effects of the goods/services purchase assistance system 1A according to the first embodiment.

More specifically, the system 1B can access the URL in the icon DB 14 to extract the goods/services image information and the text information, such as the maker/provider name, price, and goods name, and compare the extracted information with the information stored in the icon information DB 14. Where a discrepancy in the information is detected, the system 1B can replace the relevant information and regenerate an icon to replace the existing icon in the MyPage or the like. Accordingly, the generated icons are maintained in up-to-date conditions, so that the user P can check latest information via those icons.

Although the present invention have been described with respect to the first and second embodiments, the present invention is not limited to those set forth herein and various improvements and modifications are possible without departing from the scope of the invention.

For example, although the image presented by the icon is a still image according to the above embodiments, alternatively, the icon may display a motion-like image using multiple switching frames. Also, although the above embodiments use preference information as the user characteristics information, it is possible to apply other information besides preference information, such as, for example, user's behavioral characteristic information (taste in behavior).

### INDUSTRIAL APPLICABILITY

The present invention can automatically generate icons based on a user's browsing history regarding not only fashion and apparel-related websites, but also websites for selling various types of services/goods, including daily necessities, general merchandise, art works, potteries, restaurants, lodging facilities, books, music, pictures, games, electric appliances, cosmetics, medicines, sporting equipment, jewelry, precious metals, clocks, tools, toys, pets and related products, personal computers and related products, cameras and related products, cars and related products, motor cycles and related products, and the like, to provide easy and secure assistance for search or purchase of goods/services by the user using the portal site. Further, the present invention allows for search and sharing of information relating to registered goods/services browsing records and recommended goods/services via the icons. Accordingly, the present invention is applicable to various fields.

### DESCRIPTION OF REFERENCE NUMERALS

1 . . . server

1A, 1B . . . goods/services purchase assistance system

2 . . . user terminal

3 . . . web server

4 . . . network

11, 11B . . . controller

11a . . . icon generation unit

11b . . . MyPage generation unit

11c . . . MyPage edition unit

11d . . . favorite setting unit

11e . . . recommendation setting unit

11f . . . publication setting unit

11g . . . search unit

11h . . . affiliation unit

11i . . . recommendation generation unit

11j . . . preference determination unit

11k . . . screen data generation unit

11l . . . main control unit

11m . . . browsing history retrieval unit

11n . . . icon update unit

12 . . . communication transmitter/receiver

13 . . . user information database

14 . . . icon information database

15 . . . memory

16 . . . program

17 . . . recording medium

18 . . . preference information database

19 . . . shop information database

21 . . . controller

21a . . . main control unit

21b . . . browser unit

21c . . . search instruction unit

21d . . . display control unit

22 . . . communication transmitter/receiver

23 . . . operation unit

24 . . . display

25 . . . memory

PS . . . portal site

WS . . . web site

PC . . . portal site operation company

C . . . web site operation company

1. A goods/services purchase assistance method that assists purchase of goods/services from one or more websites through a portal site upon request from a user terminal,
wherein the one or more websites, each including one or more goods/services sales web pages, are browsable from a plurality of user terminals on the portal site via a communication network,
the method comprising:
storing user identification information assigned to each individual user of the portal site;
generating browsing history information of each individual user by specifying, among the goods/services sales web pages, a browsed web page browsed by the user via the user terminal, and storing the browsing history information in association with the corresponding user identification information;
generating user characteristic information that represents a user characteristic of each individual user based on the browsing history information, and storing the user characteristic information in association with the corresponding user identification information;
generating an icon that is specific to the browsed web page corresponding to the browsing history information and contains an image identifying goods/services displayed on the browsed web page, and storing each individual icon with icon identification information assigned thereto,
storing the icon identification information in association with web page identification information of the corresponding browsed web page, predetermined goods/services attribute information relating to the goods/services displayed on the corresponding browsed web page, and the user identification information and the user characteristic information of the user who browsed the corresponding browsed web page; and
enabling each individual user to publish, via the corresponding user terminal, the publishing user's own icon to other users,
wherein in displaying published icons on the corresponding user terminal in response to each individual user requesting display, where two or more duplicate icons exist which have identical web page identification information and different user identification information, a higher priority is assigned to an icon published by a user who is different than the requesting user and is more similar than others to the requesting user in terms of the user characteristic, and
the published icons are displayed according to the assigned priorities, thereby allowing the requesting user to use the displayed icons as reference information during goods/service purchase.

2. The goods/services purchase assistance method according to claim 1, wherein the user's preference relating to a particular item of goods/services is used as the user characteristic.

3. The goods/services purchase assistance method according to claim 1, wherein the user's preference obtained by identifying a plurality of words that appear frequently in the goods/services attribute information of the user and reprioritizing the identified words is used as the user characteristic.

4. The goods/services purchase assistance method according to claim 1, wherein only the duplicate icon published by a user assigned a highest priority is selectively displayed where two or more duplicate icons are present for display on the user terminal.

5. The goods/services purchase assistance method according to claim 1, wherein the goods/services attribute information of the icon is updated either at predetermined time intervals, or where the same icon has been selected by any of the users for a predetermined number of times or more.

6. The goods/services purchase assistance method according to claim 1, wherein
each individual user is assigned a dedicated icon display field that displays icons generated from the plurality of websites, and
icons associated with the user identification information corresponding to a user other than the user owing the icon display field, in addition to icons associated with the user identification information corresponding to the user owning the icon display field, are displayable in the icon display field.

7. A goods/services purchase assistance system that assists purchase of goods/services from one or more websites through a portal site upon request from a user terminal,
wherein the one or more websites, each including one or more goods/services sales web pages, are browsable from a plurality of user terminals on the portal site via a communication network,
the system comprising:
a user identification information memory means that stores user identification information assigned to each individual user of the portal site;
a browsing history information memory means that generates browsing history information of each individual user by specifying, among the goods/services sales web pages, a browsed web page browsed by the user via the user terminal, and stores the browsing history information in association with the corresponding user identification information;
a user characteristic information memory means that generates user characteristic information that represents a user characteristic of each individual user based on the browsing history information, and stores the user characteristic information in association with the corresponding user identification information;
an icon generation means that generates an icon that is specific to the browsed web page corresponding to the browsing history information and contains an image identifying goods/services displayed on the browsed web page, and stores each individual icon with icon identification information assigned thereto,
an icon information memory means that stores the icon identification information in association with web page identification information of the corresponding browsed web page, predetermined goods/services attribute information relating to the goods/services displayed on the corresponding browsed web page, and the user identification information and the user characteristic information of the user who browsed the corresponding browsed web page; and
an icon publication means that enables each individual user to publish, via the corresponding user terminal, the publishing user's own icon to other users;
wherein in displaying published icons on the corresponding user terminal in response to each individual user requesting display, where two or more duplicate icons exist which have identical web page identification information and different user identification information, a higher priority is assigned to an icon published by a user who is different than the requesting user and is more similar than others to the requesting user in terms of the user characteristic, and
the published icons are displayed according to the assigned priorities, thereby allowing the requesting user to use the displayed icons as reference information during goods/service purchase.

8. The goods/services purchase assistance system according to claim 7, wherein the user's preference relating to a particular item of goods/services is used as the user characteristic.

9. The goods/services purchase assistance system according to claim 7, wherein the user's preference obtained by identifying a plurality of words that appear frequently in the goods/services attribute information of the user and reprioritizing the identified words is used as the user characteristic.

10. The goods/services purchase assistance system according to claim 7, wherein only the duplicate icon published by a user assigned a highest priority is selectively displayed where two or more duplicate icons are present for display on the user terminal.

11. The goods/services purchase assistance system according to claim 7, wherein the goods/services attribute information of the icon is updated either at predetermined time intervals, or where the same icon has been selected by any of the users for a predetermined number of times or more.

12. The goods/services purchase assistance system according to claim 7, wherein
each individual user is assigned a dedicated icon display field that displays icons generated from the plurality of websites, and
icons associated with the user identification information corresponding to a user other than the user owing the icon display field, in addition to icons associated with the user identification information corresponding to the user owning the icon display field, are displayable in the icon display field.

13. A non-transitory computer readable medium storing a goods/services purchase assistance program that assists purchase of goods/services from one or more websites through a portal site upon request from a user terminal,
wherein the one or more websites, each including one or more goods/services sales web pages, are browsable from a plurality of user terminals on the portal site via a communication network,
the program causing a computer to perform the steps of:
storing user identification information assigned to each individual user of the portal site;
generating browsing history information of each individual user by specifying, among the goods/services sales web pages, a browsed web page browsed by the user via the user terminal, and storing the browsing history information in association with the corresponding user identification information;
generating user characteristic information that represents a user characteristic of each individual user based on the browsing history information, and storing the user characteristic information in association with the corresponding user identification information;
generating an icon that is specific to the browsed web page corresponding to the browsing history information and contains an image identifying goods/services displayed on the browsed web page, and storing each individual icon with icon identification information assigned thereto,
storing the icon identification information in association with web page identification information of the corresponding browsed web page, predetermined goods/services attribute information relating to the goods/services displayed on the corresponding browsed web page, and the user identification information and the user characteristic information of the user who browsed the corresponding browsed web page; and
enabling each individual user to publish, via the corresponding user terminal, the publishing user's own icon to other users,
wherein in displaying published icons on the corresponding user terminal in response to each individual user requesting display, where two or more duplicate icons exist which have identical web page identification information and different user identification information, a higher priority is assigned to an icon published by a user who is different than the requesting user and is more similar than others to the requesting user in terms of the user characteristic, and the published icons are displayed according to the assigned priorities, thereby allowing the requesting user to use the displayed icons as reference information during goods/service purchase.

14. The non-transitory computer readable medium according to claim 13, wherein the user's preference relating to a particular item of goods/services is used as the user characteristic.

15. The non-transitory computer readable medium according to claim 13, wherein the user's preference obtained by identifying a plurality of words that appear frequently in the goods/services attribute information of the user and reprioritizing the identified words is used as the user characteristic.

16. The non-transitory computer readable medium according to claim 13, wherein only the duplicate icon published by a user assigned a highest priority is selectively displayed where two or more duplicate icons are present for display on the user terminal.

17. The non-transitory computer readable medium according to claim 13, wherein the goods/services attribute information of the icon is updated either at predetermined time intervals, or where the same icon has been selected by any of the users for a predetermined number of times or more.

18. The non-transitory computer readable medium according to claim 13, wherein
each individual user is assigned a dedicated icon display field that displays icons generated from the plurality of websites, and
icons associated with the user identification information corresponding to a user other than the user owing the icon display field, in addition to icons associated with the user identification information corresponding to the user owning the icon display field, are displayable in the icon display field.
